(19) United States
(12) Patent Application Publication
(10) Pub. No.: US 2026/0339904 A1
(43) Pub. Date: Oct. 29, 2026

(54) Log Schematizer Using Agentic Framework

(71) Applicant: Cribl, Inc., San Francisco, CA (US)

(72) Inventors: Dritan Bitincka, Edgewater, NJ (US); Ledion Bitincka, San Francisco, CA (US); Nikhil Mungel, San Francisco, CA (US); Chinmay Kulkarni, Sunnyvale, CA (US); Patrick Wied, San Francisco, CA (US); Connor Swanson, San Francisco, CA (US); Guthrie Andres, Boston, MA (US)

(21) Appl. No.: 19/658,359

(22) Filed: Apr. 24, 2026

Related U.S. Application Data
(60) Provisional application No. 63/796,233, filed on Apr. 28, 2025.

(51) Int. Cl. G06F 16/21; G06F 16/2452

(52) U.S. Cl. CPC G06F 16/211; G06F 16/24524

(57) ABSTRACT

A plurality of automated agents cooperate to generate a data pipeline that transforms event data from a data source into records conforming to a schema. A first agent obtains sample log data from the data source. A second agent infers a log type using a log type registry. A third agent selects the schema using a schema registry. A fourth agent generates a pipeline plan from the sample log data, log type, and schema. A fifth agent generates the data pipeline, which includes an ordered arrangement of data processing functions that deliver schema-conforming records to a destination. Each agent invokes a language model and runs on a server system invoked by a client through successive requests. Each request includes a client-maintained context object reflecting prior steps, and the server system does not retain state between the requests.

### CROSS REFERENCE TO RELATED APPLICATIONS

This application claims the benefit of U.S. Provisional Patent Application Serial No. 63/796,233, filed on Apr. 28, 2025, the entire disclosure of which is incorporated herein by reference.

### FIELD

The present disclosure relates to data processing platforms, and more particularly to log schematization using an agentic framework.

### BRIEF DESCRIPTION OF THE DRAWINGS

The description herein references the accompanying drawings wherein like reference numerals refer to like parts throughout the several views unless otherwise noted or otherwise clear from context.

FIG. 1 is a block diagram of an example of a computing environment for a data processing platform.

FIG. 2 is a block diagram of an example internal configuration of a computing device.

FIG. 3 is a block diagram of an example of an automated agent in an agentic framework architecture.

FIG. 4 is a block diagram of an example of a pipeline generation framework architecture incorporating log schematization.

FIG. 5A is a flow diagram of an example of an operational flow of a pipeline generation framework architecture incorporating log schematization.

FIG. 5B is a data flow diagram of an example of pipeline-generation prompt assembly for a pipeline agent.

FIG. 6A is a sequence diagram of example interactions among a user device, a frontend, a schematizer agent, a schema agent, and a log type agent during data collection and schema selection phases of pipeline generation.

FIG. 6B is a sequence diagram of example interactions among a user device, a frontend, a schematizer agent, a pipeline agent, and a pipeline plan agent during pipeline plan creation and pipeline creation/validation phases of pipeline generation.

FIGS. 7A, 7B, 7C, 7D, and 7E are examples of a user interface of a pipeline generation framework architecture.

FIG. 8 is a flowchart of an example of a log-schematization method associated with log schematization using an agentic framework.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, network node, system, computer program product, non-transitory computer-readable medium, computing device, and/or processing system as described or substantially described herein with reference to and as illustrated by the drawings and the specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

Modern data processing platforms are utilized in enterprise information technology (IT) infrastructures to collect, process, and analyze vast amounts of data from diverse sources. Such data processing platforms may be data observability platforms that enable the observation of the state of a large interconnected system at a particular point or points in time based on the ingestion of large amounts of data relating to the system (e.g., which often will take the form of voluminous log files, events, and similar data). These platforms may incorporate multiple interconnected components, including data ingestion tools, processing pipelines, search capabilities, and data storage solutions. Such data processing platforms may process data in a real-time or near-real-time fashion. For example, in such a system, information may be received, processed while in memory, and then stored or transmitted to a destination. For example, such a system may process gigabytes or terabytes of data in real-time or near-real-time over short periods of time, such as seconds, minutes, or hours.

A feature of advanced data processing platforms is their ability to handle various data types and formats, including logs, metrics, traces, and security events. These platforms may offer both push and pull-based data ingestion methods, allowing for flexible data collection from a wide range of sources. Once data is ingested, it can be routed through processing pipelines that consist of a series of functions that perform specific operations such as parsing, filtering, transforming, or enriching the data. The resulting data may then be output to a destination, which may include storing the resulting data or providing the resulting data to another platform or application.

In addition to data processing capabilities, these platforms may include search and analytics tools that enable users to query and analyze data across multiple datasets. Some platforms incorporate artificial intelligence (AI)-assisted features to help users create queries, visualize data, and troubleshoot issues more efficiently. Furthermore, integrated data lake solutions may be available, providing long-term storage for full-fidelity data that can be easily searched or replayed as needed.

Modern enterprise information technology infrastructures generate vast amounts of operational data. Applications, cloud services, network devices, security tools, and user endpoints each emit continuous streams of messages describing their behavior over time. These messages, which include logs, metrics, traces, and security events, are collected and processed by data processing platforms that may be referred to as data observability platforms. A data observability platform may be configured to facilitate the observation of the state of a large interconnected system at a point in time or across an interval of time based on the ingestion of large volumes of data relating to the system.

A data processing platform of this kind may include a number of interoperating sub-platforms. A search platform (which may also be referred to as a query platform or a search service) may be configured to facilitate querying and analysis of data across multiple datasets, including data held in external datastores that are queried in place without being moved. A stream platform (which may also be referred to as a real-time processing platform or a pipeline execution platform) may be configured to ingest data from a data source and to route the data through one or more data pipelines that perform configurable operations on the data before delivery to one or more destinations. Examples of destinations include, but are not limited to, a log analytics system, an object store, a search index, a security information and event management (SIEM) system, and a data lake. An edge platform (which may also be referred to as an edge processing platform) may be configured to perform data processing and analysis at the network edge, closer to the data sources. A lake platform (which may also be referred to as a data lake platform) may be configured to provide long-term storage of large volumes of diverse data, typically as objects stored in open, non-proprietary formats. In some implementations, the edge platform includes a fleet of edge nodes distributed at points of presence near one or more data sources, and the data processing platform may include a fleet-management component configured to distribute configurations to the edge nodes, to monitor operational status of the edge nodes, and to receive captured event data from the edge nodes for provision as the sample log data to the schematizer agent. In some implementations, the lake platform may support replay of previously stored event data, such that a bounded set of events associated with the data source that were stored by the lake platform may be selected and replayed for provision as the sample log data to the schematizer agent. In some implementations, the client and the server system may communicate through an application programming interface (API) endpoint exposed by the server system, the API endpoint receiving the plurality of successive requests and returning the respective results of the automated agents to the client. In some implementations, the user interface may be configured to present a diff view that compares an existing data pipeline or an existing schema to a modified data pipeline or a modified schema, the diff view identifying additions, removals, and modifications between the existing and modified versions.

A feature of these data processing platforms is the handling of heterogeneous data formats. The data emitted by different software or hardware producers is typically written in different layouts, with different field names, different nesting structures, and different conventions for representing values such as timestamps, identifiers, and severity levels. Downstream applications such as log analytics systems, security information and event management systems, and search indices operate most effectively when records are in a consistent structured layout, which may be referred to as a schema. A schema refers to a specification of field names, field types, and semantic conventions against which records from diverse sources may be aligned. Examples of schemas include, but are not limited to, the Open Cybersecurity Schema Framework (OCSF), the Elastic Common Schema (ECS), and the Unified Data Model (UDM).

The process of transforming records emitted by a data source into records conforming to a schema may be referred to as log schematization. Log schematization may be implemented by a data pipeline. A data pipeline may refer to an ordered arrangement of data processing functions configured to consume input event data, transform the input event data, and deliver transformed records to a destination. The ordered arrangement may include a linear sequence of functions, a directed graph that includes branching and merging, or a configuration that includes conditional routing. The data processing functions of the data pipeline may include, but are not limited to, a parsing function configured to extract fields from an input event, an enrichment function configured to add information to a record from one or more external sources, a normalization function configured to align field names and values with conventions of the schema, a redaction function configured to mask or remove sensitive field values, and a routing function configured to deliver a record to at least one of the destinations.

A technical challenge in operating a data processing platform of this kind is that data pipelines have historically been authored manually. A user, typically a data engineer or a platform operator, inspects sample records from the data source, identifies the format of the records, selects an appropriate schema, writes extraction and transformation rules such as regular expressions or scripts that implement the rules, and iteratively tests the resulting data pipeline against further samples. The manual authoring process imposes a number of limitations. The latency between a decision to ingest a new data source and the arrival of usable, schematized data in the data processing platform is gated by the time taken for human authoring of the data pipeline. The manual process increases load on the data processing platform because interactive authoring through a user interface consumes memory, compute, and network resources at each iteration. The manual process increases the likelihood of errors because regular-expression authoring and schema mapping are tasks in which small mistakes may propagate through large data volumes. The manual process tends to produce fewer data pipelines and shallower extraction rules, because engineering capacity does not scale with the growth of the number of data sources. The result is that data corresponding to many data sources is held in a raw or partially processed form, which reduces the value of the downstream analytical tools that consume the data.

One approach that partially addresses the manual-authoring limitations is the use of template libraries and connector catalogs, in which a vendor or open-source project ships pre-built data pipelines for common data sources. Approaches of this kind provide coverage of popular data sources, but tend to fall behind when data source formats change and tend to offer limited coverage when uncommon data sources are introduced. A technical shortcoming of this approach is that a static library of pre-built data pipelines does not adapt to a data source the library has not anticipated.

A further approach is to use a language model to generate a data pipeline in a single request, in which the language model receives a sample of input event data and an indication of a schema and is asked to produce the data pipeline in one output. This approach faces its own limitations. The language model may hallucinate field names or schema definitions when attempting to reproduce schemas from training data of the language model, may produce syntactically invalid regular expressions or scripting code, and may generate configurations that do not conform to the format accepted by the data processing engine. A technical shortcoming of this approach is that, absent a per-step grounding mechanism, output of the language model is not constrained to known-good options.

A still further approach is to orchestrate a multi-step workflow in which multiple language-model invocations, each scoped to a narrower sub-task, cooperate to generate the data pipeline. When orchestration of a workflow of this kind is held on a server side, a server system maintains state across multiple requests from a client. Server-held state introduces technical limitations of its own. The server system becomes difficult to scale horizontally because an incoming request related to an ongoing workflow is routed back to the server that holds the corresponding state, a property which may be referred to as session affinity. Recovery from a server failure is complicated because in-memory state is lost when the server restarts. Long-running workflows in which a user pauses for review or edits at intermediate stages are difficult to support because the session state may outlive a capacity of the server to retain it. A technical shortcoming of this approach is that server-held workflow state prevents the server system from being horizontally scaled across interchangeable servers and prevents the workflow from surviving server failures or long user pauses.

Implementations of this disclosure address problems such as these by providing a multi-agent architecture in which orchestration of a pipeline-generation workflow is held on a client rather than on a server system. The client maintains a context object that accumulates workflow state across a plurality of successive requests to the server system, and the server system retains no state associated with the workflow between the successive requests. By way of this architectural choice, the server system may be deployed as a horizontally scalable fleet of interchangeable servers without session affinity at a load balancer fronting the server system, and the workflow may span long-running human-review steps and survive server failures without loss of workflow progress.

The architecture coordinates a plurality of automated agents, each of which performs a narrowly scoped sub-task and each of which is invoked as an independent stateless server call. Decomposition of the pipeline-generation workflow into task-narrow automated agents provides a mechanism by which each automated agent may be grounded by a correctness technique tailored to its sub-task, including retrieval from one or more curated registries, constrained decoding of the language model, and deterministic post-generation validation, so that hallucination and other failure modes of language-model-driven code generation are reduced.

An automated agent refers to a software component including processor-executable instructions that, when executed by one or more processors, perform one or more of invoking a language model component, invoking one or more tools external to the language model component, and consulting one or more registries, and that returns a result in response to a request. An automated agent is not a human or an organization acting as an agent of a principal.

A language model component refers to a logical abstraction through which an automated agent invokes language-model functionality by invoking one or more language models. A language model refers to a machine-learning model trained to generate or classify sequences of tokens in a natural or formal language, and may include large language models, smaller language models, proprietary models, and commercially available models. A language model component may include one or more language models, one or more interfaces to one or more language models, or a combination thereof. In some implementations, the language model component invoked by a given automated agent includes a single language model that is invoked by the given automated agent for each request received by the given automated agent. In some implementations, the language model component invoked by a given automated agent includes a plurality of language models, and the language model component selects, for a given invocation, at least one language model from among the plurality of language models based on a characteristic of the sample log data, a computational budget associated with the respective request, or a combination thereof. In some implementations, the at least one language model invoked by a first automated agent differs from the at least one language model invoked by a second automated agent, such that different language models are invoked by different automated agents of the plurality of automated agents.

In some implementations, at least one language model invoked by a first automated agent and the at least one language model invoked by a second automated agent include a same language model, such that a single language model is shared among two or more automated agents of the plurality of automated agents. In some implementations, the language model component includes a local language model executed by the server system, a remote language model accessed through a network interface, a proxied language model accessed through an intermediate service, or a combination thereof. An automated agent may invoke a language model to carry out a narrowly scoped sub-task, may invoke one or more tools such as registry-lookup tools or validator tools to ground or check output of the language model, and may return the resulting result to the client that invoked the automated agent.

The agentic framework architecture includes a first automated agent, which may be referred to as a schematizer agent, that handles user interactions and orchestrates the workflow by delegating sub-tasks to a plurality of worker automated agents and summarizing the outputs of the worker automated agents for presentation to the client. The schematizer agent receives sample log data from the client, invokes the language model to characterize a format of the sample log data, and returns a schematization result to the client, which the client writes into the context object before transmitting a further request in the successive requests. The sample log data refers to a representative set of events drawn from the data source that is used to inform subsequent steps of the workflow without processing the full volume of events from the data source during generation of the data pipeline. The schematization result may include one or more of a characterization of a format of the sample log data, a proposed log type, a proposed schema, a proposed pipeline plan, and one or more candidate alternatives for any of the foregoing. In some implementations, the schematization result further includes an identifier of the sample log data, a reference to the sample log data, a confidence indicator associated with one or more elements of the schematization result, and a status indicator identifying a current step of the workflow at which the schematization result was produced.

Sample log data may be obtained from the data source through one or more of several mechanisms. In some implementations, sample log data is obtained by receiving, from the data source, a bounded set of events streamed over a data-ingestion connection during a sampling window. In some implementations, sample log data is obtained by reading a bounded set of events from a capture buffer maintained by the edge platform or the stream platform for the data source. In some implementations, sample log data is obtained by uploading, through the client, a file containing events representative of the data source. In some implementations, sample log data is obtained by replaying, from the lake platform, a bounded set of previously stored events associated with the data source. In some implementations, the sample log data may be obtained through a synchronous input mechanism in which the user provides the sample log data at a time the log-schematization workflow is initiated. In some implementations, the sample log data may be obtained through an asynchronous input mechanism in which the data processing platform captures sample log data from the data source over a sampling window and makes the sample log data available to the schematizer agent when the log-schematization workflow is initiated.

The agentic framework architecture further includes a second automated agent, which may be referred to as a log type agent, that infers a log type of the sample log data. A log type refers to a label identifying a format family associated with the data source, such as a label associated with a firewall vendor, a virtual private cloud flow-log family, a web-server access log format, an operating system audit log format, or a container orchestration audit log format. The log type agent infers the log type by consulting a log type registry. A log type registry refers to a curated catalog of log type definitions, which in some implementations includes on the order of one hundred or more log types across many vendors, stored on disk in a format optimized for retrieval. A log type definition in the log type registry may include representative raw events, field names, field structures, and other descriptive data for the log type. In some implementations, the log type agent retrieves a plurality of candidate log type definitions from the log type registry, where the retrieval may be based on a similarity measure computed between a representation of the sample log data and representations of entries in the log type registry. Examples of similarity measures include, but are not limited to, a cosine similarity between vector embeddings of the sample log data and entries of the log type registry, a lexical similarity score such as a best-matching-25 (BM25) score, a fuzzy string similarity score, and a structural schema similarity score computed between the field-level structure of the sample log data and the field-level structure of entries of the log type registry.

The log type agent invokes the language model with the sample log data and the candidate log type definitions as input and returns, to the client, the log type selected from among the candidate log type definitions. When no log type in the log type registry corresponds to the sample log data, the log type agent may return a sentinel indicating an unknown log type (e.g., a designated string or a null value indicating that no matching log type was identified). The representation of the sample log data against which a similarity measure is computed may take different forms depending on the similarity measure employed. For a cosine similarity, the representation of the sample log data may be a vector embedding of the sample log data produced by an embedding model. For a lexical similarity score such as a best-matching-25 score, the representation of the sample log data may be a token sequence or bag-of-tokens derived from the sample log data. For a fuzzy string similarity score, the representation of the sample log data may be a concatenated character sequence derived from one or more sample events of the sample log data. For a structural schema similarity score, the representation of the sample log data may be a field-level structure inferred from the sample log data, specifying field names, inferred field types, and nesting relationships.

In some implementations, the log type agent may iterate the invocation of the language model when an initial output of the language model does not correspond to any log type definition in the log type registry. Iteration may include re-invoking the language model with a revised prompt that identifies the out-of-registry output and requests an output constrained to the candidate log type definitions, invoking a second language model that produces an alternative selection, or applying a classify-check post-condition that verifies membership of the output in the log type registry before the output is returned to the client. Iteration may be bounded by a retry budget specified by a policy of the log type agent, and when the retry budget is exhausted without a registry-valid output the log type agent returns the sentinel indicating the unknown log type. In some implementations, the log type registry and the schema registry may be extensible by an operator of the data processing platform. An operator may add a new log type definition to the log type registry, modify an existing log type definition, or remove a log type definition, through one or more administrative interfaces of the data processing platform, and the new log type definition becomes available for retrieval by the log type agent in subsequent invocations. Similarly, an operator may add, modify, or remove a schema definition in the schema registry through one or more administrative interfaces of the data processing platform.

The agentic framework architecture further includes a third automated agent, which may be referred to as a schema agent, that selects a schema based on the sample log data and the log type. The schema agent retrieves a plurality of candidate schemas associated with the log type from a schema registry. A schema registry refers to a curated catalog of schema definitions, which may include schema definitions drawn from industry standards such as the Open Cybersecurity Schema Framework, the Elastic Common Schema, and the Unified Data Model, as well as schemas previously saved within the stream platform by the operator or a user of the data processing platform. The schema registry may be accessed through a retrieval tool configured to read the schema definitions from disk and return the schema definitions to the schema agent. The schema agent invokes the language model with the sample log data, the log type, and the candidate schemas as input, and returns, to the client, the schema selected from among the candidate schemas.

In some implementations, when no candidate schema in the schema registry satisfies a coverage condition with respect to the sample log data, the schema agent may generate a new schema and store the new schema in the schema registry for future retrieval. A coverage condition refers to a criterion that evaluates whether a candidate schema adequately represents the fields present in the sample log data. Examples of coverage conditions include, but are not limited to, a threshold percentage of fields of the sample log data that are mapped to fields of the candidate schema, a criterion that fields of a specified kind be present in the candidate schema, a similarity-score threshold between the structure of the sample log data and the structure of the candidate schema, and a criterion based on absence of material field types within the candidate schema. For example, in some implementations, the coverage condition may be satisfied when at least eighty percent of the fields of the sample log data are mapped to fields of the candidate schema.

The schema agent may generate the new schema through one or more of several mechanisms. In some implementations, the schema agent generates the new schema by invoking the language model with the sample log data, the log type, and a schema-generation prompt, the language model producing a schema definition as output, the schema definition specifying field names, field types, and semantic conventions derived from the sample log data. In such implementations, the schema-generation prompt provided to the language model may include a specification of a schema format accepted by the data processing platform, one or more few-shot examples of correctly formed schema definitions, and one or more of the candidate schemas retrieved from the schema registry as a baseline from which fields may be added, removed, or modified. In some implementations, the schema agent generates the new schema programmatically by inspecting the sample log data, extracting a set of field names and inferred field types from the sample log data, and assembling the extracted field names and inferred field types into a schema definition according to a predefined format. In some implementations, the schema agent generates the new schema by cloning a closest candidate schema retrieved from the schema registry and extending the cloned schema with one or more additional fields derived from fields of the sample log data that are not covered by the cloned schema. In some implementations, the schema agent generates the new schema by returning, to the client, a draft schema and receiving, from the client, one or more modifications to the draft schema elicited from a user, the modifications being incorporated into the new schema before the new schema is stored in the schema registry.

The new schema stored in the schema registry is thereby made available for retrieval in subsequent invocations of the schema agent. In some implementations, the schema registry stores the schema definitions directly as complete definitions within the schema registry. In some implementations, the schema registry stores references to schema definitions held external to the schema registry, such as references to schema definitions held in a remote schema service, in a distributed file system, or in a federated schema store, and the schema registry retrieves the schema definitions through the references when the schema definitions are needed by the schema agent. In some implementations, the schema agent may receive, from the client, a user-provided schema in whole or in part. The user-provided schema may be provided as a complete schema definition that bypasses retrieval from the schema registry, or as a partial schema fragment that the schema agent merges with one or more candidate schemas retrieved from the schema registry to produce the schema selected for the sample log data. In some implementations, the schema agent may support iterative refinement of the schema selection. In such implementations, the schema agent returns a plurality of candidate schemas or a ranked list of candidate schemas to the client, receives from the client a request for alternative schemas or a refinement criterion, and re-invokes the language model to produce a revised schema selection based on the refinement criterion. In some implementations, a new schema stored in the schema registry by the schema agent may be associated with a scope and a version. The scope may identify a tenancy, an operator, or a data source to which the new schema is applicable, such that retrieval of schemas from the schema registry may be restricted to schemas whose scope matches a scope of the sample log data. The version may identify a revision of the new schema, such that successive modifications to the new schema produce successive versions retrievable from the schema registry, and a particular version of the new schema may be selected for use by the schema agent.

The agentic framework architecture further includes a fourth automated agent, which may be referred to as a pipeline plan agent, that generates a pipeline plan based on the sample log data, the log type, and the schema. A pipeline plan refers to a description of the transformations that the data pipeline will perform, together with a mapping between fields of the sample log data and fields of the schema. In some implementations, the pipeline plan agent invokes the language model to produce the pipeline plan as a structured representation. The structured representation may specify a sequence of data processing functions, one or more parameters for each of the data processing functions, and the mapping between fields of the sample log data and fields of the schema.

Conformance of the structured representation to a defined shape may be enforced during generation of the pipeline plan through constrained decoding of the language model. Constrained decoding refers to one or more techniques that restrict the tokens the language model may produce at each position of the output so that the resulting sequence conforms to a specified grammar or schema. Examples of constrained decoding include, but are not limited to, grammar-constrained decoding, decoding constrained by a schema expressed as a schema for JavaScript Object Notation (JSON), finite-state-machine-driven decoding, and biasing of token-selection logits against tokens that would violate the specified structure. The pipeline plan agent may employ further alignment techniques including few-shot prompting, in which one or more representative example plans are included in the prompt provided to the language model, and chain-of-thought prompting, in which the language model is directed to articulate intermediate reasoning steps.

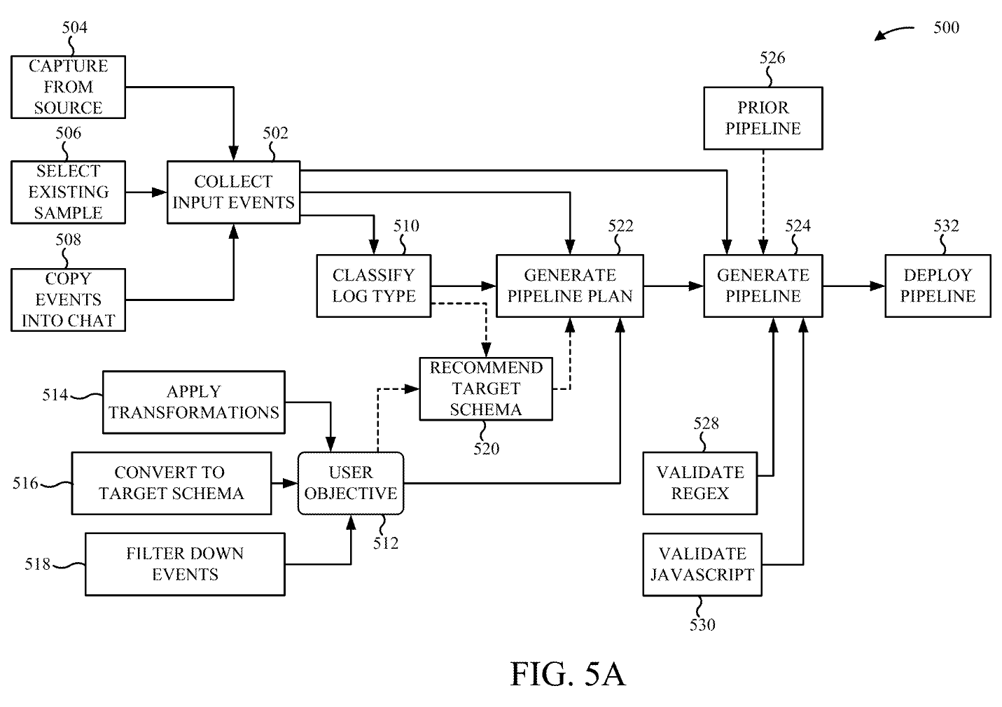

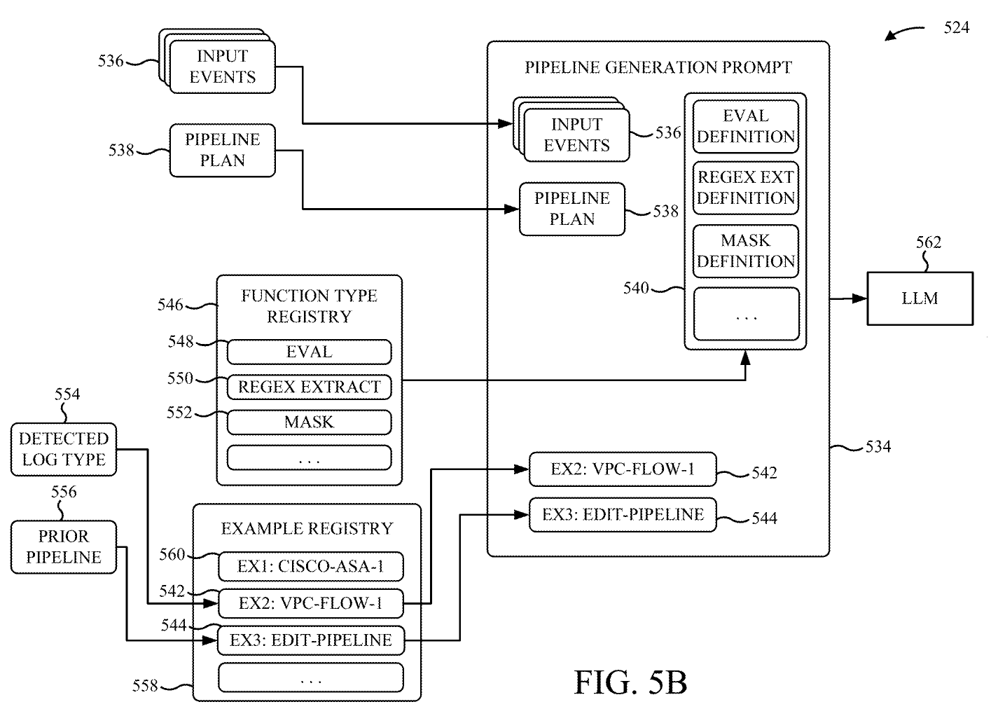

The agentic framework architecture further includes a fifth automated agent, which may be referred to as a pipeline agent, that generates the data pipeline based on the pipeline plan. The pipeline agent compiles the pipeline plan into an executable configuration for a data processing engine. The pipeline agent compiles the pipeline plan into the executable configuration through one or more of several mechanisms. In some implementations, the pipeline agent compiles the pipeline plan into the executable configuration by invoking the language model with the pipeline plan and a pipeline-generation prompt, such as the pipeline-generation prompt described with reference to FIG. 5B, the language model producing one or more fragments of the executable configuration as output. In such implementations, the pipeline-generation prompt provided to the language model may include the pipeline plan, a specification of a syntax accepted by the data processing engine, one or more definitions of data processing function types available to the data processing engine, and one or more few-shot examples of correctly formed executable configurations. In some implementations, the pipeline agent compiles the pipeline plan into the executable configuration by way of a deterministic transducer that maps each data processing function specified in the pipeline plan, together with one or more parameters thereof, to a corresponding configuration fragment in the syntax accepted by the data processing engine, according to a mapping between function-type identifiers and configuration fragment templates. In some implementations, the pipeline agent compiles the pipeline plan into the executable configuration by a hybrid mechanism, in which a first portion of the executable configuration is produced by the language model and a second portion of the executable configuration is produced by the deterministic transducer, or in which the language model generates a draft of the executable configuration that is subsequently normalized or post-processed by the deterministic transducer.

In some implementations, the pipeline agent embeds within the executable configuration a comment section that holds a natural-language representation of the pipeline plan, one or more portions thereof, or a rationale derived therefrom. The comment section may be inserted as one or more comment fragments recognized by the data processing engine as non-executing annotations, such that a first comment fragment may be positioned at a header of the executable configuration to hold a summary of the pipeline plan, and one or more further comment fragments may be positioned adjacent to a respective data processing function of the ordered arrangement to hold a description of a transformation performed by the respective data processing function, a mapping between a source field and a destination field carried out by the respective data processing function, a rationale for inclusion of the respective data processing function in the executable configuration, or a combination thereof. The comment section may be ignored by the data processing engine during execution of the data pipeline but may be retained as part of the executable configuration when the executable configuration is edited through the user interface, exported to a file, imported from a file, persisted to a version-control repository, or transferred between tenancies, such that design rationale expressed in the pipeline plan persists with the data pipeline across subsequent modifications. In some implementations, where the data pipeline is modified subsequent to generation by the pipeline agent, the comment section may be updated by re-invocation of the pipeline plan agent or the pipeline agent to reflect the modification, by entry of revised annotation text by the user through the user interface, or by a combination thereof.

In some implementations, invocation of the language model by the pipeline agent for compilation of the pipeline plan into the executable configuration is performed by way of a further automated agent that is itself invoked by the pipeline agent, the further automated agent being configured to interact with the language model on behalf of the pipeline agent. In such implementations, the pipeline agent may provide the pipeline plan, a specification of the syntax accepted by the data processing engine, and one or more few-shot examples to the further automated agent as an input, and the further automated agent may return the executable configuration, or one or more fragments thereof, to the pipeline agent as an output. The further automated agent may invoke a language model that is distinct from the language model invoked by the pipeline agent for other sub-tasks, may hold specialized prompts for compilation of the pipeline plan into the executable configuration, and may invoke one or more tools external to the language model for the purpose of compilation. The executable configuration defines the ordered arrangement of the data processing functions and the parameters for each of the data processing functions, in a syntax that the data processing engine is configured to interpret. The data processing engine may be the stream platform or another data processing engine external to the stream platform.

The pipeline agent may invoke deterministic validator tools during or after generation, including a regular-expression validator tool configured to test the syntactic validity of regular expressions in the executable configuration and a scripting-language validator tool configured to test the syntactic validity of scripting fragments in the executable configuration. In some implementations, the pipeline agent may invoke further tools to retrieve contextual information for edit-pipeline scenarios in which an existing data pipeline is being modified rather than a new data pipeline being produced. In some implementations, the pipeline agent may invoke a retrieve-context tool configured to retrieve, for an edit-pipeline scenario, one or more of an existing executable configuration of an existing data pipeline, a history of modifications to the existing executable configuration, a specification of a modification objective provided by the user, and a portion of event data to which the existing executable configuration is applied. The pipeline agent may incorporate the retrieved context into the pipeline-generation prompt provided to the language model such that the language model is informed of the existing data pipeline in generating a modified executable configuration. In some implementations, the data pipeline preserves, in each record produced by the data pipeline, a field holding an original raw event text from which the record was derived. The field may be referred to as a `_raw` field or an equivalent, and serves to maintain fidelity between the raw event data from the data source and the transformed record, such that downstream consumers of the data pipeline may recover the original event text if required.

A validation sub-process may follow generation of the data pipeline. The validation sub-process may include applying the data pipeline to at least a portion of the sample log data, comparing an output of the data pipeline to the schema, and, conditioned on a result of the comparison, committing the data pipeline to the data processing engine for use in processing data from the data source. Comparison of the output of the data pipeline to the schema may include evaluating whether the output records conform to the field names, field types, and semantic conventions of the schema. When the result of the comparison indicates insufficient conformance to the schema, the data pipeline may be returned to an earlier stage of the workflow for modification, which may include modification of the pipeline plan, modification of the schema selection, modification of the data pipeline itself, or capture of additional sample log data.

Comparison of the output of the data pipeline to the schema may be carried out by one or more conformance tests. In some implementations, the conformance test determines, for each record produced by the data pipeline, whether each field specified by the schema is present in the record and whether the field value of each such field is of a type consistent with the schema. In some implementations, the conformance test further determines whether the record includes fields not specified by the schema, and whether absence of a field specified by the schema is permitted under the schema. In some implementations, a result of the conformance test is reported as a fraction of records that pass the conformance test with respect to a total number of records produced by the data pipeline applied to the sample log data, and the data pipeline is committed to the data processing engine when the fraction satisfies a commit condition.

Validation of the data pipeline may include both a syntactic validation and a schema-conformance validation. Syntactic validation may be performed by the deterministic validator tools invoked by the pipeline agent during or after generation of the executable configuration, and evaluates whether regular expressions, scripting fragments, and configuration structures are syntactically valid according to the syntax accepted by the data processing engine. Schema-conformance validation may be performed by the validation sub-process after generation of the data pipeline, and evaluates whether records produced by the data pipeline conform to the schema according to the field names, field types, and semantic conventions of the schema. In some implementations, a quality-control artifact may be produced by the validation sub-process and stored by the data processing platform for subsequent review. The quality-control artifact may include one or more of the sample log data, the pipeline plan, the data pipeline, a result of the conformance test, and a trace of the invocations of the automated agents that produced the data pipeline, such that the data pipeline may be audited by an operator of the data processing platform or may be reproduced at a later time.

In the architecture described here, orchestration of the workflow is held on the client side rather than the server side. Each of the automated agents executes on a server system including one or more servers and is invoked by the client through a respective request of a plurality of successive requests. The client maintains a context object, where the context object in each successive request reflects output received by the client in response to one or more prior successive requests of the plurality of successive requests. In some implementations, the context object includes an identifier of the data source, the sample log data or a reference to the sample log data, the log type after inference by the log type agent, the schema after selection by the schema agent, and the pipeline plan after generation by the pipeline plan agent. The context object may further include configuration parameters, a tenancy identifier, a trace identifier, partial results from prior steps of the workflow, or a combination thereof.

In some implementations, a pipeline name for the data pipeline may be received from a user as a user-specified pipeline name through a user interface of the client, such that the user-specified pipeline name is associated with the data pipeline in place of an automatically generated pipeline name. The user-specified pipeline name may be received prior to generation of the data pipeline by the pipeline agent, concurrent with generation of the data pipeline, or following generation of the data pipeline. Upon receipt of the user-specified pipeline name, the client may write the user-specified pipeline name into the context object, into a name attribute of the executable configuration, into a pipeline registry of a stream platform on which the data pipeline is deployed, or a combination thereof, such that the user-specified pipeline name accompanies the data pipeline when the data pipeline is committed to the data processing engine, displayed through the user interface, exported to a file, or otherwise persisted. In some implementations, where the user-specified pipeline name is not received from the user, the client may assign an automatically generated pipeline name derived from one or more of the log type, the schema, an identifier of the data source, and a timestamp of the log-schematization workflow. In some implementations, the client may validate the user-specified pipeline name against one or more naming rules, the naming rules including a uniqueness rule with respect to existing data pipeline names, a length rule, a character-set rule, or a combination thereof, and may prompt the user to revise the user-specified pipeline name where the user-specified pipeline name does not satisfy a given naming rule.

When the client invokes an automated agent, the client transmits a request to the server system, with the request including the context object as the context object exists at that point in the workflow. Upon receiving a response from the automated agent, the client writes the respective output of the automated agent into the context object before transmitting a next request in the plurality of successive requests. A context object refers to a client-maintained data structure that carries workflow state across the successive requests. The context object may take any of several representational forms. In some implementations, the context object is a structured document, such as a JavaScript Object Notation (JSON) document, an Extensible Markup Language (XML) document, a protocol-buffer message, or a document in another serialization format, the structured document including one or more fields carrying the workflow state.

In some implementations, the context object is a message sequence including an ordered plurality of messages, each of the messages corresponding to a prior invocation of the language model by the automated agents, the message sequence including at least a prompt and a response associated with each prior invocation. In some implementations, the context object is a claims payload of a digitally signed token carried in the request, such as a payload of a JSON Web Token (JWT) or an equivalent, the claims payload carrying the workflow state as one or more claims of the token. In some implementations, the context object is a collection of header fields carried in the request, the header fields carrying one or more elements of the workflow state as a respective value of a respective header field. In some implementations, the context object is any combination of the foregoing representational forms, or another client-maintained state representation that carries workflow state across the successive requests in a manner that permits the server system to process each of the successive requests independently.

The server system, which may include one or more servers, does not retain state associated with the method between the successive requests. Each of the successive requests may be transmitted over a stateless application-layer protocol such as the hypertext transfer protocol (HTTP) or an equivalent, and the server system does not use a session identifier to associate any of the successive requests with any other of the successive requests. Each of the successive requests may be independently authenticated through credentials carried in the request, such as bearer tokens, mutual transport-layer security certificates, or equivalents, and may be independently authorized through scope or policy evaluation performed at the time of the request. The integrity of the context object may be validated by the server system through verification of a signature of the context object. The signature of the context object may be computed by the client using a keyed message-authentication code such as a hash-based message authentication code (HMAC), a digital signature such as an Ed25519 signature, or another cryptographic integrity mechanism.

Verification of the signature may be performed by the server system on receipt of each request, providing a mechanism by which the server system may trust the client-maintained context object even though the workflow state does not reside on the server system. The cryptographic key used to compute the signature of the context object may be provisioned and managed through one or more of several key-management mechanisms. In some implementations, a shared secret is established between the client and the server system during an initial authentication handshake, and the shared secret is used by the client to compute the signature of the context object for subsequent successive requests. In some implementations, the client holds a private signing key and the server system holds a corresponding public verification key, the public verification key being retrieved by the server system from a public-key directory keyed to an identifier of the client. In some implementations, the cryptographic key is rotated at an interval specified by a policy of the server system, with an overlap window during which a prior key and a current key are each accepted by the server system for signature verification. In some implementations, each of the successive requests is routed by a load balancer fronting the server system to any available server of the server system without reference to a session identifier, such that a first request of the successive requests may be processed by a first server of the server system and a second request of the successive requests may be processed by a second server of the server system different from the first server. In such implementations, the load balancer maintains no per-client session table, and a request is not required to be routed to a server that previously processed a prior request of the successive requests.

Each of the automated agents may include a prompt-injection check configured to detect, within input data received by the automated agent, one or more indicia that the input data includes an instruction intended to override or subvert the prompt used to invoke the language model. Examples of indicia include, but are not limited to, a string that purports to be a system message of the language model, a string that purports to instruct the language model to disregard a prior prompt, a string that purports to exfiltrate data from a prior step of the workflow, and a string that contains a delimiter or control token recognized by the language model. Detection of the prompt-injection check may be performed by one or more of a regular-expression matcher applied to the input data, a classifier model trained to identify instruction-like content in event data, and a rule set that compares the input data against a registry of known prompt-injection patterns. Upon detection, the automated agent may take one or more corrective actions, including excluding the offending input from the prompt provided to the language model, escaping or neutralizing the offending input before the prompt is provided to the language model, returning an error indicator to the client in place of a result, and logging the detection event for subsequent review by an operator of the data processing platform.

Because the server system does not retain workflow state between the successive requests, the server system may be deployed as a horizontally scalable fleet of interchangeable servers, without session affinity at a load balancer fronting the server system. A failure of any server in the server system does not result in loss of workflow progress, because the context object holding the workflow state is held with the client rather than with the server system. The plurality of automated agents may be deployed as independent stateless services, and at least two of the first automated agent, the second automated agent, the third automated agent, the fourth automated agent, and the fifth automated agent may execute on different ones of a plurality of servers of the server system. In some implementations, automated agents that involve more computationally demanding language-model invocations may execute on servers provisioned with acceleration hardware such as one or more graphics processing units (GPUs), while automated agents that involve lighter computation may execute on general-purpose servers of the server system. In some implementations, at least one of the automated agents may select the language model invoked for a given request from a plurality of language models, where the selection may be based on a characteristic of the sample log data, on a computational budget associated with the request, or on a combination thereof. Examples of characteristics of the sample log data include, but are not limited to, a volume of the sample log data, a complexity indicator derived from the sample log data, a sensitivity classification of the sample log data, and a format-family indicator of the sample log data. Examples of considerations including the computational budget include, but are not limited to, a latency budget associated with the response, a monetary cost budget associated with the request, and a service-tier classification associated with a tenancy on behalf of which the request is issued.

The agentic framework architecture further supports tool use by the automated agents beyond registry consultation. An automated agent may invoke one or more tool calls as part of processing a request. A tool call refers to a structured invocation, by or on behalf of an automated agent, of a function or service that is external to the language model, the tool call carrying input parameters and returning a result. The tool calls may include at least one tool call that reads from the log type registry, at least one tool call that reads from the schema registry, at least one tool call that validates a generated fragment, and at least one tool call that retrieves contextual information from storage. Tool calls may be executed on the server side, in which case the automated agent appends a result of the tool call to an internal message sequence and continues execution of the automated agent. Tool calls may be executed on the client side, in which case execution of the automated agent is yielded back to the client together with an intermediate message sequence, the client executes the tool, appends a result of the tool call to the message sequence, and reinvokes the automated agent with the updated message sequence. Execution of tool calls on the client side may be appropriate for tools that interact with user-interface elements, with local filesystem content, or with resources that are addressable from the client environment.

Because the multi-agent architecture decomposes the pipeline-generation workflow into task-narrow automated agents, each automated agent may be grounded by a correctness mechanism tailored to its sub-task. Reduction of hallucinations by the automated agents may be approached through these complementary mechanisms. Large data payloads, such as lengthy captured events and large schema definitions, may be passed among the automated agents by reference rather than by value, so that the language models are not asked to reproduce the payloads verbatim and the attendant risk of token-level corruption is reduced. Retrieval from curated registries grounds the outputs of the log type agent and the schema agent in known-good definitions, so that the language models select from a bounded set of candidates rather than producing candidates from training-data memory of the language models. Constrained decoding at the pipeline plan agent restricts the generated pipeline plan to conforming structures, so that downstream consumers of the pipeline plan do not have to parse free-form output.

Deterministic validator tools invoked by the pipeline agent confirm the syntactic validity of regular expressions, scripting fragments, and configuration structures within the executable configuration, so that outputs of the language model that do not satisfy the validator tools are either corrected or rejected before the data pipeline is committed. In some implementations, when the context object exceeds a token budget associated with an invocation of the language model by one of the automated agents, the automated agent may apply one or more prompt-chaining techniques to partition the invocation into a plurality of sub-invocations of the language model. Examples of prompt-chaining techniques include, but are not limited to, summarization of prior-step outputs within the context object, selection of a relevant subset of fields of the context object for inclusion in the prompt, and sequential partial invocations in which an output of a first sub-invocation is incorporated into a prompt of a second sub-invocation.

Implementations of this disclosure include a method of log schematization carried out substantially as described above. Implementations further include one or more non-transitory computer-readable storage media storing instructions that, when executed by one or more processors, cause the one or more processors to perform operations substantially as described above for the method. Implementations further include a system including a memory and a processor set configured to execute instructions stored in the memory to cause the system to perform operations substantially as described above for the method. Embodiments of the method, of the storage media, and of the system may share the structural and operational features described above, including the plurality of automated agents, the stateless server system, the client-maintained context object, the retrieval-grounded log type and schema selections, the structured pipeline plan, the executable configuration compiled by the pipeline agent, the validation sub-process, and the per-request authentication and context-object signature validation.

Through the agentic framework architecture described here, and through the data pipelines that are generated by operation of the agentic framework architecture, heterogeneous event data from a wide range of data sources may be transformed into records conforming to a consistent schema and delivered to one or more destinations without the latency, load, and error rate associated with manual pipeline authoring, while avoiding the horizontal-scaling limitations associated with server-held workflow state. The result is a data processing platform in which a larger number of data sources may be schematized with richer extraction, at reduced latency of pipeline onboarding, reduced memory, compute, and network load on the data processing platform, and higher operational reliability, without the horizontal-scaling limitations associated with server-held workflow state.

Further details of techniques for log schematization using an agentic framework are described herein with initial reference to systems and devices in which they can be implemented.

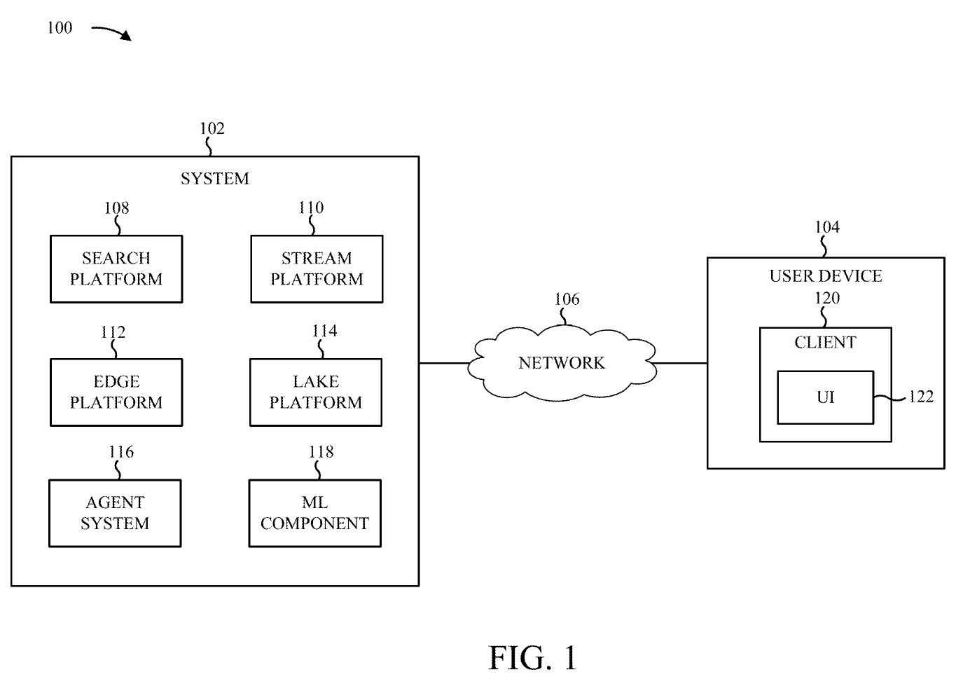

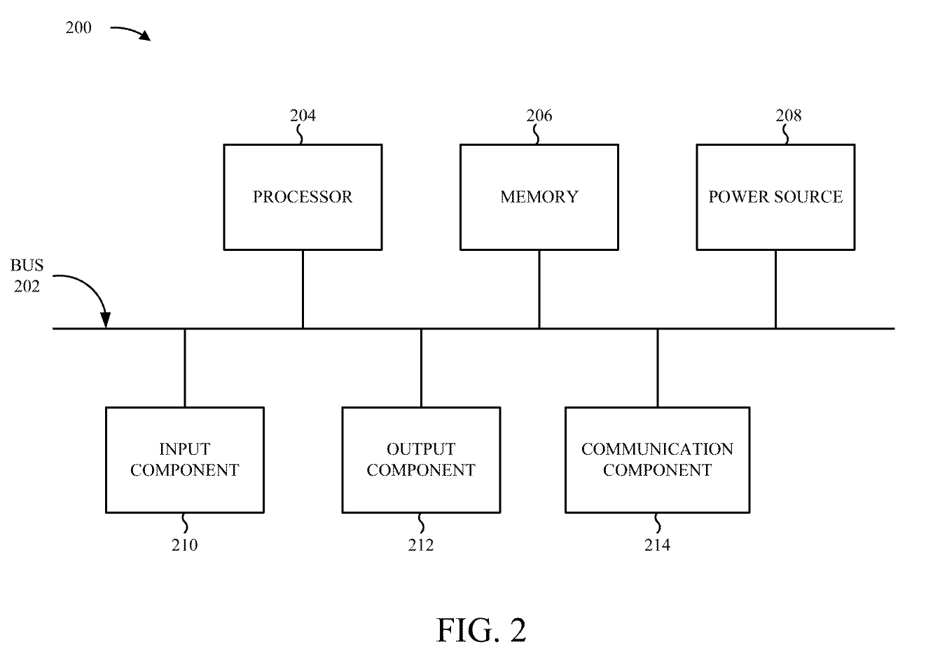

FIG. 1 is a block diagram of an example of a computing environment 100 for a data processing platform. As shown, the computing environment 100 includes a system 102, a user device 104, and a network 106, which are configured to interact with each other to provide a data processing platform. In some implementations, additional or fewer components may be included in the computing environment 100. The components and their arrangement within the computing environment 100 may be used to implement the techniques disclosed herein. In some implementations, the system 102 may be implemented in a software as a service model, while in other implementations it may be implemented as a standalone system. In some implementations, the system 102 and the user device 104 may be implemented together on the same device. In some implementations, the system 102 and/or the user device 104 may be implemented using one or more computing devices, such as the computing device 200 illustrated in FIG. 2.

The system 102 may include one or more servers, virtual servers, machines, or virtual machines configured to perform the operations of the various components of the system 102. The system 102 includes one or more data processing platforms including, for example, a search platform 108, a stream platform 110, an edge platform 112, and a lake platform 114. The system 102 also includes a machine learning (ML) component 118. The search platform 108, the stream platform 110, the edge platform 112, the lake platform 114, and the ML component 118 may include one or more interconnected components that perform various data processing and communication functions within the data processing platform. In some implementations, two or more of the search platform 108, the stream platform 110, the edge platform 112, the lake platform 114, and the ML component 118 may be configured to share at least a portion of their processing or computing resources. For example, the system 102 may be implemented using one or more computing devices, such as the computing device 200, to which portions of the search platform 108, the stream platform 110, the edge platform 112, the lake platform 114, and the ML component 118 have been distributed. In some implementations, the search platform 108, the stream platform 110, the edge platform 112, the lake platform 114, and the ML component 118 may be implemented in software as a service (SaaS) model. In some implementations, one or more of the search platform 108, the stream platform 110, the edge platform 112, the lake platform 114, and the ML component 118 may be implemented as dedicated standalone computing devices that are separate from one another. In some implementations, any of the search platform 108, the stream platform 110, the edge platform 112, the lake platform 114, and the ML component 118 may be implemented using two or more computing devices (e.g., the computing device 200, as shown in FIG. 2). In some implementations, any of the search platform 108, the stream platform 110, the edge platform 112, the lake platform 114, and the ML component 118 may be implemented using cloud-based computing devices (e.g., software as a service, infrastructure as a service, platform as a service, or another type of cloud-based service).

The system 102 may be in communication with the user device 104 via the network 106. The network 106 may be wired or wireless (e.g., Wi-Fi) and may include a local area network (LAN), wide area network (WAN) (e.g., the Internet), and/or an extranet. The user device 104 may be a computing device (e.g., the computing device 200, as shown in FIG. 2) that is configured to communicate with the system 102. For example, the user device 104 may be a desktop computer, a laptop computer, a smartphone, a tablet computer, a wearable computer, a server, a voice assistant device, or the like. The search platform 108, the stream platform 110, the edge platform 112, the lake platform 114, and the ML component 118 may include respective user interfaces for interacting with the user device 104. In various implementations, the user device 104 may interact with any of the search platform 108, the stream platform 110, the edge platform 112, the lake platform 114, and the ML component 118 via the network 106.

The search platform 108 may be configured to facilitate efficient querying and analysis of data across multiple datasets. Depending on the implementation, the search platform 108 may include search-in-place techniques that do not utilize or utilize limited indexing, indexing mechanisms, query parsers, and result aggregators, or combinations thereof to facilitate information retrieval. The search platform 108 may interface with other components of the system 102 to provide search capabilities.

The search platform 108 may be designed to explore data in place, without requiring data to be moved to specialized storage first. This capability allows users to query logs, metrics, or any sort of machine data with less infrastructure overhead (e.g., indexing and associated storage). In some implementations, the search platform 108 may support a wide array of data sources, including data lakes, object stores, cloud data warehouses, analytics services and platforms, and application programming interface (API) endpoints. The search platform 108 may seamlessly integrate with other components of the system 102, such as the stream platform 110 and the edge platform 112, to provide a comprehensive data exploration solution.

The search platform 108 may generate queries in the required target query language for each underlying system. This abstraction layer may enable the search platform 108 to query data in place, using the specific language or technology associated with the data's storage location.

The search platform 108 may employ a distributed architecture to enhance performance and scalability. In some implementations, the search platform 108 may dynamically spin up multiple parallel search executors to facilitate the speed of searches. The search platform 108 may coordinate and federate results streaming in from multiple systems, interpret the results, and present a single, unified view of the result set. In some implementations, the search platform 108 may have the capability to extract structured field names and values even from unstructured source data, further enhancing its utility in complex data processing environments.

The stream platform 110 may be configured to execute and manage real-time data processing pipelines within the computing environment 100. In some implementations, the stream platform 110 may include components for data ingestion, transformation, or routing, among other examples. Individual data pipelines may be configured to obtain input data from a specific data source, perform a specific set of functions on that data (which may include extracting fields of data from the input data, transforming the data, or combinations thereof), and then output the resulting data to a destination.

The stream platform 110 may be designed to handle various data types and formats, including logs, metrics, traces, or security events, among other examples. In some implementations, the stream platform 110 may offer both push and pull-based data ingestion methods, allowing for flexible data collection from a wide range of sources. Once data is ingested, it may be routed through processing pipelines that consist of a series of functions, each performing specific operations such as parsing, filtering, transforming, or enriching the data. The stream platform 110 may utilize a routing table to evaluate incoming events against filter expressions, determining the appropriate pipeline for processing.

In some aspects, the stream platform 110 may include pre-processing, processing, and post-processing pipeline capabilities. Pre-processing pipelines may be attached to sources to condition or normalize events before they are delivered to processing pipelines. Processing pipelines may be the core event processing pipelines attached directly to routes. Post-processing pipelines may be attached to destinations to normalize events before they are sent out. The stream platform 110 may allow users to configure these pipelines through a graphical user interface or by importing JavaScript object notation (JSON) configurations. In some implementations, the stream platform 110 may support the use of function groups to streamline complex pipeline displays and improve organization.

The stream platform 110 may also include features for managing data output to various destinations. In some cases, the stream platform 110 may support both streaming and non-streaming destinations, with the ability to handle backpressure events when destinations are unreachable. The stream platform 110 may offer options for blocking, dropping, or queuing data when faced with destination issues. In some implementations, the stream platform 110 may provide load balancing capabilities for certain destinations, enhancing distribution efficiency. In some implementations, the stream platform 110 may support the use of persistent queues to prevent data loss and facilitate reliable data delivery, even in scenarios where destinations experience temporary outages or performance issues.

The edge platform 112 is designed to handle data processing and analysis at the network edge, closer to the data sources. In some implementations, the edge platform 112 may include lightweight processing units and local caching mechanisms to reduce latency and bandwidth usage. The edge platform 112 may communicate with the stream platform 110 and the lake platform 114 to facilitate edge-based data collection for logs, metrics, or application data.

The edge platform 112 may be designed to operate on various types of endpoints, including servers, cloud or datacenter virtual machines, and container nodes such as Amazon ECS instances or Kubernetes nodes. In some implementations, the edge platform 112 may utilize a lightweight package of core components, often referred to as an edge node, which can be deployed directly on customer endpoints. This approach may allow for efficient data collection and initial processing at the source, reducing the volume of data that needs to be transmitted to the stream platform 110.

The edge platform 112 may include capabilities for collecting data from local filesystems, APIs, and system states on the endpoints where it is deployed. In some cases, the edge platform 112 may offer processing, routing, and distribution functionalities similar to those found in the stream platform 110, but optimized for lower overall volume and reduced resource requirements at the endpoint level.

In some implementations, the edge platform 112 may support the creation of edge fleets, which are collections of edge nodes that can be managed centrally. The edge platform 112 may include features for fleet management, allowing administrators to configure, update, and monitor multiple edge nodes from a centralized control plane. This capability may enable organizations to efficiently manage large-scale deployments of edge processing units across diverse environments. The edge platform 112 may also integrate with the search platform 108, potentially allowing for distributed search queries to be executed directly on edge nodes, further reducing the need to transfer large volumes of data to centralized systems for analysis.

The lake platform 114 provides long-term storage and management capabilities for large volumes of diverse data. In some implementations, the lake platform 114 may utilize distributed storage systems and support various data formats to accommodate the heterogeneous nature of data processed within the computing environment 100. The lake platform 114 may interact with the search platform 108 to enable comprehensive historical analysis during debugging operations.

The lake platform 114 may be designed to provide a scalable and flexible data storage solution that complements the real-time processing capabilities of the stream platform 110 and the edge platform 112. In some implementations, the lake platform 114 may utilize object storage technologies to create a centralized repository for long-term data retention. This approach may allow organizations to store large volumes of raw, unprocessed data in its original format, preserving the full fidelity of the information for future analysis and replay.

The lake platform 114 may organize data into datasets, which can be customized based on various criteria such as data source, type, or business unit. In some aspects, the lake platform 114 may support both built-in and custom datasets, providing flexibility in how data is structured and accessed. The data stored in the lake platform 114 may be compressed and stored in open, non-proprietary formats such as JSON, which can help reduce storage costs and avoid vendor lock-in. Additionally, the lake platform 114 may include features for data lifecycle management, allowing administrators to set retention policies and archive or delete data based on predefined rules.

In some implementations, the lake platform 114 may integrate closely with the search platform 108, enabling users to perform complex queries and analytics on historical data without the need for data movement or transformation. This integration may allow for seamless data exploration across both real-time and historical datasets, providing a comprehensive view of an organization's data landscape. The lake platform 114 may also support data replay functionality, allowing users to reprocess historical data through the stream platform 110 or send it to other destinations for further analysis or compliance purposes. This capability may be particularly useful for debugging, testing new data processing pipelines, or recovering from data loss in downstream systems.

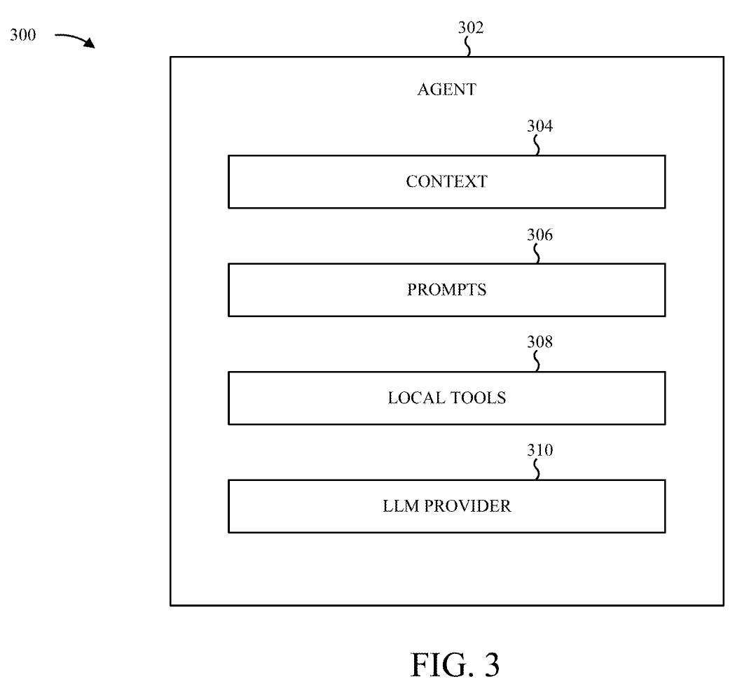

The system 102 also includes an agent system 116 which provides an agentic framework and implementations of agents that interoperate to perform tasks within system 102. The agent may be implemented in software and executed on a computing device. Such an agent is described further with respect to FIG. 3.

The agent may invoke an ML component 118 which is integrated within the system 102 to provide advanced analytical capabilities. In some implementations, the ML component 118 may be or include any number of models such as, for example, a natural language processing (NLP) model, an LLM, or a neural network, among other examples. In some implementations, the ML component 118 can be trained using ML techniques. For example, ML techniques can include supervised ML techniques, semi-supervised ML techniques, or unsupervised ML techniques. In some implementations, the ML component 118 may be trained using reinforcement learning algorithms. In some implementations, the ML component 118 or one or more aspects thereof may be implemented external to the system 102. For example, in some implementations, the ML component 118 may be maintained by an entity other than an entity that maintains the system 102. For example, the ML component 118 may include a commercially-available LLM or LLM platform.

FIG. 2 shows a block diagram of an example of a computing device 200 capable of performing functions described herein. The computing device 200 may be used to implement one or more components of the computing environment 100. The computing device 200 may be, be similar to, include, or be included in, an apparatus for performing one or more methods, processes, algorithms, operations, tasks, and/or techniques, as described herein. The computing device 200 may be, be similar to, include, or be included in, a computing device, a laptop, a workstation, a server device, or a personal computer, among other examples. The computing device 200 includes a bus 202 that interconnects various components or units, such as a processor 204, a memory 206, a power source 208, an input component 210, an output component 212, and a communication component 214, among other examples.

The processor 204 may be a central processing unit, such as a microprocessor, and may include single or multiple processors having single or multiple processing cores. The processor 204 may include another type of device, or multiple devices, configured for manipulating or processing information. For example, the processor 204 may include multiple processors interconnected in one or more manners, including hardwired or networked. The operations of the processor 204 may be distributed across multiple devices or units that can be coupled directly or across a local area or other suitable type of network. The processor 204 may include a cache, or cache memory, for local storage of operating data or instructions.

The memory 206 includes one or more memory components, which may each be volatile memory or non-volatile memory. The memory 206 may include non-transitory memory. The volatile memory can be random access memory (RAM) (e.g., a DRAM module, such as DDR SDRAM). The non-volatile memory of the memory 206 may be a disk drive, a solid state drive, flash memory, or phase-change memory. In some implementations, the memory 206 may be distributed across multiple devices. For example, the memory 206 may include network-based memory or memory in multiple clients or servers performing the operations of those multiple devices.

The memory 206 may include data for access by the processor 204. For example, the memory 206 may include executable instructions, application data, or an operating system, among other examples. The executable instructions may include one or more application programs, which may be loaded or copied, in whole or in part, from non-volatile memory to volatile memory to be executed by the processor 204. For example, the executable instructions may include instructions for performing techniques described in this disclosure. In some implementations, the application data may include functional programs, such as a computational programs, analytical programs, database programs, and so on. The operating system may be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 may be an interface to an external power distribution system. In an example, the power source 208 may be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The input component 210 and/or the output component 212 may include one or more input interfaces and/or output interfaces configured for facilitating communication between the computing device 200 and one or more peripheral devices such as, for example, one or more sensors, detectors, displays, input devices, or other devices configured for facilitating interaction with the computing device 200 or the environment around the computing device 200. An input device may, for example, include a positional input device, such as a mouse, touchpad, touchscreen, or the like; a keyboard; or another suitable human or machine interface device. An output device may, for example, include a display, such as a liquid crystal display, a cathode-ray tube, a light emitting diode display, or other suitable display. In some implementations, the peripherals devices may include a geolocation component, such as a global positioning system (GPS) location unit. In some examples, the peripheral devices may include a temperature sensor for measuring temperatures of components of the computing device 200, such as the processor 204.

The communication component 214 may include an interface for facilitating a connection or link to a network. The communication component 214 may include a wired network interface or a wireless network interface. The computing device 200 may communicate with other devices via the communication component 214 using one or more network protocols, such as using Ethernet, TCP, IP, power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, a cellular communication protocol, another protocol, or a combination thereof. For example, the computing device 200 can communicate with a database server.

The communication component 214 may include a transceiver, which may include a transmitter or a receiver. In some configurations, one or a combination of antenna(s), modem(s), multiple input multiple output (MIMO) detectors, receive processors, transmit processors, and/or the transmit MIMO processors may be included in the transceiver. The transceiver may be under control of or used by one or more processors, and in some aspects in conjunction with processor-readable code stored in the memory, to perform aspects of the methods, processes, techniques, and/or operations described herein.

In the description herein, sentences describing a system, an apparatus, or a device as taking an action (such as performing, determining, initiating, receiving, calculating, deciding, computing, processing, etc.) are to be understood that some appropriate component of the system, apparatus, or device as taking the action. Such components may refer to hardware and/or software configured to take the action.

An apparatus, computing device (e.g., the computing device 200), one or more components of a computing device, or a system, among other examples, described herein may include one or more chips, system-on-chips (SoCs), chipsets, packages, and/or devices that individually or collectively constitute or comprise a processing system. A processing system may include processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “processor” or “processor circuitry”).

The terms “processor,” “processing circuitry,” “processing component,” “processor component,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories. Additionally or alternatively, in some examples, one or more of the processors may be preconfigured to perform various functions or operations described herein without requiring configuration by software.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

An “engine” refers to a component constructed, programmed, configured, or otherwise adapted to perform a specific function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, interpreted, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines include a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations and should generally not be limited to any particular implementation exemplified herein, unless such limitations are expressly called out. s used herein, the term “model” encompasses its plain and ordinary meaning. A model may include, among other things, one or more engines which receive an input and compute an output based on the input.

FIG. 3 is a block diagram of an example of an automated agent 302 in an agentic framework architecture 300. The agentic framework architecture 300 may be hosted by the agent system 116 of the system 102 shown in FIG. 1. As used herein, an automated agent refers to a software component including processor-executable instructions that, when executed by one or more processors, perform one or more of invoking one or more language models, invoking one or more tools external to the one or more language models, and consulting one or more registries, and that returns a result in response to a request. An automated agent is not a human or an organization acting as an agent of a principal.

As shown in FIG. 3, the automated agent 302 includes a context 304, one or more prompts 306, one or more local tools 308, and a language-model (LLM) provider 310. In some implementations, two or more of the context 304, the prompts 306, the local tools 308, and the LLM provider 310 may be integrated into a single component. In some implementations, one or more of the context 304, the prompts 306, the local tools 308, and the LLM provider 310 may be implemented using any number of computing devices such as the computing device 200 shown in FIG. 2. For example, one or more of the context 304, the prompts 306, the local tools 308, and the LLM provider 310 may be distributed among a plurality of computing devices, such as among a cluster of servers, among a set of virtual machines, among a set of containerized services, among a plurality of nodes of a cloud-computing infrastructure, or a combination thereof. In some implementations, two or more of the context 304, the prompts 306, the local tools 308, and the LLM provider 310 may be configured to share at least a portion of the processing or computing resources thereof.

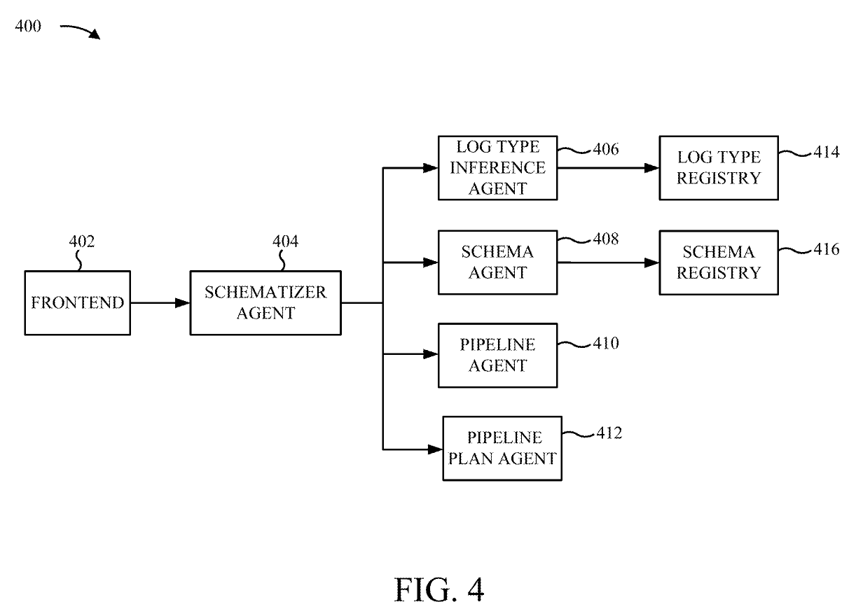

The automated agent 302 (which may also be referred to as a first automated agent, a second automated agent, a third automated agent, a fourth automated agent, or a fifth automated agent when distinguished from other automated agents in a plurality of automated agents described with reference to FIG. 4) may be, be similar to, include, or be included in a software component executing on the system 102 shown in FIG. 1. The automated agent 302 may be configured to receive a request from a client such as the client 120 shown in FIG. 1, to process the request using one or more of the context 304, the prompts 306, the local tools 308, and the LLM provider 310, and to return a response to the client 120. In some implementations, the automated agent 302 may be configured to operate in a stateless manner, such that the automated agent 302 may be configured, at execution, to receive a prior state from the client 120 where available and, at completion of processing, at a pause, or at an interrupt, to output a current state to the client 120 for storage within a context object maintained by the client 120, such that the automated agent 302 does not retain state locally between successive requests from the client 120.

In some implementations, the automated agent 302 may be configured to operate as part of an agentic framework architecture that supports a plurality of architectural patterns for interaction among a plurality of automated agents. For example, in some implementations, the automated agent 302 may operate within a supervisor-worker architecture in which a supervisor automated agent provides a task to the automated agent 302 and validates or oversees the output produced by the automated agent 302. In some implementations, the automated agent 302 may operate within a mesh architecture in which a plurality of automated agents interoperate on a non-hierarchical basis. In some implementations, the automated agent 302 may operate within a collaborative architecture in which a plurality of automated agents work on the same task and the outputs thereof are evaluated to produce a final result. In some implementations, the automated agent 302 may operate within a handoff architecture in which individual automated agents are specialized and in which a given automated agent may identify, based on available information regarding the specialization of other available automated agents, an automated agent to which a task is to be handed off.

The context 304 (which may also be referred to as an agent context, a context store, or a context map) may be configured to store state and configuration information available to the automated agent 302 at the time of processing a request. The context 304 may be, be similar to, include, or be included in an in-memory key-value store. In some implementations, the context 304 may be configured to provide guardrails for the automated agent 302 that limit a range of tasks the automated agent 302 may perform, limit a range of output the automated agent 302 may produce, or a combination thereof. For example, the context 304 may include identifiers, configuration parameters, tenancy identifiers, trace identifiers, partial results from prior steps of a workflow, or a combination thereof, as received from the client 120 shown in FIG. 1 as part of a context object included in a request.

The prompts 306 (which may also be referred to as a prompt library, a prompt set, or a prompt catalog) may be configured to provide instructions to a language model invoked by the automated agent 302. The prompts 306 may be, be similar to, include, or be included in a plurality of prompt templates stored on disk, stored in memory, or stored in a remote prompt store accessible to the automated agent 302. In some implementations, a given prompt of the prompts 306 may be selected based on a current state stored in the context 304 and, together with appropriate context from the context 304, provided as input to a language model invoked by the automated agent 302. In some implementations, the prompts 306 may incorporate alignment techniques for the language model, including chain-of-thought prompting, few-shot prompting, instruction-tuning-compatible prompting, or a combination thereof, to reduce hallucinations by the language model. In some implementations, the prompts 306 may support prompt chaining, in which a shorter prompt with instructions and a listing of available additional context is provided to the language model first, the language model may invoke a tool of the local tools 308 to retrieve the additional context, and the retrieved additional context is provided back to the language model to continue inference.

The local tools 308 (which may also be referred to as deterministic tools, in-process tools, or agent-local tools) may be configured to support deterministic operations that may be executed by the automated agent 302 locally. The local tools 308 may be, be similar to, include, or be included in executable code executed in the same process as the automated agent 302 or in a closely coupled process accessible to the automated agent 302. In some implementations, the local tools 308 may include a tool configured to select a given prompt of the prompts 306 and an appropriate portion of the context 304 for inference by a language model where an input is within a predetermined range. For example, the local tools 308 may employ techniques such as regular-expression evaluation and reading information from files in order to determine which prompts of the prompts 306 and which portions of the context 304 to utilize. In some implementations, the local tools 308 may include a tool configured to take an action other than inference, such as returning an error, requesting clarification, handing off the request to another automated agent, or another suitable action.

In some implementations, the automated agent 302 may be configured to invoke one or more tools external to the local tools 308. The automated agent 302 may include a listing or a set of specifications for one or more remote tools, which may include, for example, an application programming interface that may be invoked to execute a given remote tool. A remote tool may include a tool associated with the user interface 122 of the client 120 shown in FIG. 1 such that, when invoked by the automated agent 302, execution of the remote tool is performed by the client 120 rather than by the automated agent 302. In some implementations, the automated agent 302 may invoke a tool call that reads from a registry such as a log type registry or a schema registry described further with reference to FIG. 4.

The LLM provider 310 (which may also be referred to as a language-model provider, a model endpoint, or a model-inference provider) may be configured to indicate which language model or language models may be invoked by the automated agent 302 for inference. The LLM provider 310 may be, be similar to, include, or be included in an identifier or a specification that points to a language-model inference engine. For example, the LLM provider 310 may identify an API endpoint for a third-party-hosted language-model inference engine, a locally-hosted language-model inference engine, or a combination thereof. In some implementations, the LLM provider 310 may specify a plurality of language models available to the automated agent 302, and the automated agent 302 may select a given language model for a given request from the plurality of language models based on a characteristic of sample log data associated with the request, on a computational budget associated with the request, or on a combination thereof. For example, the characteristic of the sample log data may include a volume, a complexity indicator, a sensitivity classification, a format-family indicator, or a combination thereof. For example, the computational budget may include a latency budget, a monetary cost budget, a service-tier classification of a tenancy on behalf of which the request is issued, or a combination thereof. In some implementations, the language model invoked through the LLM provider 310 may be a large language model, a small language model, a natural-language-processing model, a neural network, or a combination thereof, as further described with reference to the ML component 118 shown in FIG. 1.

In some implementations, the automated agent 302 may operate according to a process that includes a plurality of steps. At an initial step, the automated agent 302 may receive, as input, a set of messages M, a set of remote tools T, and optionally a context C drawn from the context object maintained by the client 120 shown in FIG. 1. At a further step, the automated agent 302 may validate the input received. In some implementations, where the input is invalid in whole or in part, the automated agent 302 may return an error. At a further step, the automated agent 302 may check whether the messages M include system messages that may represent prompt-injection attempts. In some implementations, where the check fails, the automated agent 302 may return an error, hand off to another automated agent, or take another suitable action.

At a further step, the automated agent 302 may pass the messages M and a combined list of the local tools 308 and the remote tools T to a language model identified by the LLM provider 310. At a further step, the language model may invoke one or more of the local tools 308, one or more of the remote tools T, or a combination thereof, based on the input provided. At a further step, the automated agent 302 may execute a given local tool of the local tools 308 invoked by the language model and may append a result of the execution to the messages M. In some implementations, the messages M may be transmitted to the client 120 shown in FIG. 1 to facilitate maintenance of state by the client 120 within the context object. At a further step, where one or more remote tools of the remote tools T are invoked, execution of the automated agent 302 may stop and control may be yielded to the client 120, which may execute the remote tool, append a result of the execution to the messages M, and invoke the automated agent 302 again using the updated messages M. At a further step, where no tools of the local tools 308 or the remote tools T are invoked, the automated agent 302 may come to a halt and output from the language model may be returned to the client 120.

In some implementations, a plurality of automated agents such as the automated agent 302 may be orchestrated according to a handoff architecture. For example, a handoff process may receive, as input, a set of automated agents A, a set of messages M, a set of tools T, and a context C. In a main routine of the handoff process, a next-agent-selection function may be executed to obtain a next automated agent to invoke. In some implementations, where no next automated agent is determined, the handoff process may terminate and return a result stored in the messages M. In some implementations, where a next automated agent is determined, the next automated agent may be executed using a current state of the messages M, the messages M may be updated with a result of execution of the next automated agent, and the main routine may be repeated. In the next-agent-selection function, a history of prior executions of automated agents may be compared to a number of the automated agents in the set A. In some implementations, where the history of prior executions exceeds the number of the automated agents in the set A, null may be returned to indicate that no next automated agent is to be invoked. In some implementations, a specific automated agent, an ordering of automated agents, a priority of automated agents, or a combination thereof may be pre-determined or determined at runtime, and the next automated agent may be returned according to the specific automated agent, the ordering, or the priority. In some implementations, any of the automated agents in the set A may be returned as the next automated agent. In some implementations, null may be returned where none of the preceding conditions is satisfied.

In some implementations, the automated agent 302 may be deployed as a stateless service within the system 102 shown in FIG. 1 that is invoked through a stateless application-layer protocol such as the hypertext transfer protocol (HTTP), such that each invocation of the automated agent 302 by the client 120 is a respective request of a plurality of successive requests. In some implementations, each of the successive requests may be independently authenticated and independently authorized, and the system 102 may validate a signature of the context object in each of the successive requests.

In some implementations, the automated agent 302 may support asynchronous input, synchronous input, or a combination thereof. In some implementations, the automated agent 302 may support observability mechanisms that facilitate monitoring of invocations of the automated agent 302, of tool calls performed in connection with processing a request, and of language-model invocations performed in connection with processing a request. For example, the automated agent 302 may emit tracing data, log data, or metrics data to one or more of the search platform 108, the stream platform 110, the edge platform 112, and the lake platform 114 shown in FIG. 1 to facilitate subsequent query and analysis.

In some implementations, reduction of hallucinations by the language model invoked through the LLM provider 310 may be facilitated by a plurality of complementary mechanisms implemented within or in cooperation with the automated agent 302. For example, large data payloads such as lengthy sample log data or large schema definitions may be passed between the automated agent 302 and other components by reference rather than by value, such that the language model is not asked to reproduce the large data payloads verbatim. For example, retrieval of candidate values from one or more registries may ground output of the language model within a bounded set of known-good values. For example, constrained decoding may restrict output of the language model to conform to a specified grammar or schema. For example, deterministic validators implemented as part of the local tools 308 or as remote tools may check output of the language model for syntactic or structural validity prior to acceptance of the output.

In some implementations, the automated agent 302 may be configured to invoke one or more tool calls as part of processing a request, where the tool calls may include at least one tool call that reads from a log type registry, at least one tool call that reads from a schema registry, at least one tool call that validates a generated fragment, at least one tool call that retrieves contextual information from storage, or a combination thereof, as further described with reference to FIG. 4 and FIGS. 5A-5B.

In operation, the automated agent 302 receives a request from the client 120 shown in FIG. 1 through the network 106, the request including the context object maintained by the client 120. The automated agent 302 validates the request, consults the context 304, selects one or more of the prompts 306, invokes one or more of the local tools 308 and optionally one or more remote tools, invokes a language model identified through the LLM provider 310, and returns output to the client 120. The client 120 writes the output into the context object and transmits a next request of the successive requests, at which point the system 102 shown in FIG. 1 does not retain state associated with the prior request between the prior request and the next request.

FIG. 4 is a block diagram of an example of a pipeline generation framework architecture 400 incorporating log schematization. The pipeline generation framework architecture 400 may be hosted by the agent system 116 of the system 102 shown in FIG. 1, and the individual automated agents of the pipeline generation framework architecture 400 may have an internal structure as described with reference to the automated agent 302 shown in FIG. 3.

As shown in FIG. 4, the pipeline generation framework architecture 400 includes a frontend 402, a schematizer agent 404, a log type inference agent 406, a schema agent 408, a pipeline agent 410, a pipeline plan agent 412, a log type registry 414, and a schema registry 416. In some implementations, two or more of the frontend 402, the schematizer agent 404, the log type inference agent 406, the schema agent 408, the pipeline agent 410, the pipeline plan agent 412, the log type registry 414, and the schema registry 416 may be integrated into a single component. In some implementations, one or more of the frontend 402, the schematizer agent 404, the log type inference agent 406, the schema agent 408, the pipeline agent 410, the pipeline plan agent 412, the log type registry 414, and the schema registry 416 may be implemented using any number of computing devices such as the computing device 200 shown in FIG. 2. For example, one or more of the frontend 402, the schematizer agent 404, the log type inference agent 406, the schema agent 408, the pipeline agent 410, the pipeline plan agent 412, the log type registry 414, and the schema registry 416 may be distributed among a plurality of computing devices, such as among a cluster of servers, among a set of virtual machines, among a set of containerized services, among a plurality of nodes of a cloud-computing infrastructure, or a combination thereof. In some implementations, at least two of the schematizer agent 404, the log type inference agent 406, the schema agent 408, the pipeline agent 410, and the pipeline plan agent 412 may execute on different ones of a plurality of servers of the system 102 shown in FIG. 1.

The frontend 402 (which may also be referred to as a client-side orchestrator or a client-side interface) may be configured to provide an interface through which a user interacts with the pipeline generation framework architecture 400. The frontend 402 may be, be similar to, include, or be included in the client 120 shown in FIG. 1 or a component thereof. For example, the frontend 402 may include functions such as creating or saving a data pipeline, capturing or selecting event data for schematization, rendering the user interface 122 shown in FIG. 1, or a combination thereof. In some implementations, the frontend 402 may be configured to maintain a context object that reflects one or more prior steps of a log-schematization workflow, to transmit the context object to the system 102 shown in FIG. 1 with each of a plurality of successive requests, and to write a respective output of an automated agent into the context object before transmitting a next request of the successive requests.

In some implementations, the frontend 402 may be configured to execute one or more client-side tools invoked by the schematizer agent 404 during the log-schematization workflow. For example, the client-side tools may include a next-step tool, a file-save tool configured to save a sample file, a data pipeline file, a pipeline-plan file, or a combination thereof, a source-selection tool, a sample-file-selection tool, a schema-selection tool, a pipeline-selection tool, an objective-selection tool, an event-capture tool, a pipeline-validation tool, a quality-control-save tool, a restart or exit tool, or a combination thereof. In some implementations, the frontend 402 may transmit each of the successive requests across the network 106 shown in FIG. 1 using a stateless application-layer protocol such as the hypertext transfer protocol (HTTP) or a variant thereof, may sign the context object using a keyed message-authentication code such as a hash-based message-authentication code (HMAC) or using a digital signature such that the system 102 may validate a signature of the context object on receipt of each request, and may provide credentials with each of the successive requests such that each of the successive requests may be independently authenticated and independently authorized by the system 102.

In some implementations, the client-side tools may further include a pipeline-naming tool configured to receive a user-specified pipeline name from a text input of the user interface 122 shown in FIG. 1 and to associate the user-specified pipeline name with the data pipeline generated by the pipeline agent 410, in place of an automatically generated pipeline name derived by the frontend 402 from one or more of the log type, the schema, an identifier of the data source, and a timestamp of the log-schematization workflow.

The schematizer agent 404 (which may also be referred to as a first automated agent or an orchestrator agent) may be configured to obtain sample log data corresponding to a data source, to handle interactions with the frontend 402, and to orchestrate a log-schematization workflow by delegating specialized tasks to the log type inference agent 406, the schema agent 408, the pipeline agent 410, and the pipeline plan agent 412, and by summarizing outputs received from the delegated automated agents for presentation through the frontend 402. The schematizer agent 404 may be, be similar to, include, or be included in an instance of the automated agent 302 shown in FIG. 3, in which the context 304, the prompts 306, the local tools 308, and the LLM provider 310 are configured to support schematization orchestration. In some implementations, the schematizer agent 404 may be configured to receive the sample log data from the frontend 402, to invoke a language model through the LLM provider 310 to characterize a format of the sample log data, and to return a schematization result to the frontend 402, where the schematization result is written by the frontend 402 into the context object prior to transmission of a next request of the successive requests.

In some implementations, the schematizer agent 404 may be configured to execute a hand-tuned workflow, where the hand-tuned workflow is enforced using a combination of language-model alignment techniques and deterministic code checks implemented by the local tools 308 of the schematizer agent 404. In some implementations, the schematizer agent 404 may be configured to reduce hallucinations by the language model invoked through the LLM provider 310 by passing large data payloads such as lengthy sample log data or large schema definitions to and between the log type inference agent 406, the schema agent 408, the pipeline agent 410, and the pipeline plan agent 412 by reference rather than by value, such that the language model is not asked to reproduce the large data payloads verbatim. For example, the schematizer agent 404 may operate within a supervisor-worker architecture in which the schematizer agent 404 delegates tasks to the log type inference agent 406, the schema agent 408, the pipeline agent 410, and the pipeline plan agent 412 as worker automated agents, validates or oversees outputs produced by the worker automated agents, and summarizes results for presentation through the frontend 402.

The log type inference agent 406 (which may also be referred to as a second automated agent or a log type agent) may be configured to infer a log type based on the sample log data by consulting the log type registry 414. The log type inference agent 406 may be, be similar to, include, or be included in an instance of the automated agent 302 shown in FIG. 3, in which the context 304, the prompts 306, the local tools 308, and the LLM provider 310 are configured to support log type classification.

In some implementations, the log type inference agent 406 may be configured to retrieve a plurality of candidate log type definitions from the log type registry 414 and to invoke a language model through the LLM provider 310 with the sample log data and the candidate log type definitions as input, such that the log type selected by the log type inference agent 406 is selected from among the candidate log type definitions. In some implementations, the retrieval of the candidate log type definitions from the log type registry 414 may be based on a similarity measure computed between a representation of the sample log data and representations of entries in the log type registry 414. Examples of the similarity measure include, but are not limited to, a cosine similarity between vector embeddings of the sample log data and the entries, a lexical similarity score such as a best-matching-25 (BM25) score, a fuzzy string similarity score, a structural schema similarity score computed between a field-level structure of the sample log data and a field-level structure of the entries, or a combination thereof.

In some implementations, the log type inference agent 406 may include, as one of the local tools 308, a classification tool that controls operation of the log type inference agent 406. The classification tool may cause the log type inference agent 406 to execute an iterative process including invoking the language model to classify input event data to a known log type, checking output of the language model against the log type registry 414, and constraining outputs of the language model to pre-identified values of the log type registry 414, such that where the output of the language model does not correspond to a pre-identified value, a sentinel indicating an unknown log type is returned. In some implementations, the log type inference agent 406 may invoke a tool call that reads from the log type registry 414.

The schema agent 408 (which may also be referred to as a third automated agent) may be configured to select a schema based on the sample log data and the log type, by consulting the schema registry 416. The schema agent 408 may be, be similar to, include, or be included in an instance of the automated agent 302 shown in FIG. 3, in which the context 304, the prompts 306, the local tools 308, and the LLM provider 310 are configured to support schema retrieval and generation.

In some implementations, the schema agent 408 may be configured to retrieve a plurality of candidate schemas associated with the log type from the schema registry 416 and to invoke a language model through the LLM provider 310 with the sample log data, the log type, and the candidate schemas as input, such that the schema selected by the schema agent 408 is selected from among the candidate schemas. In some implementations, the schema agent 408 may include, as one of the local tools 308, a schema-retrieval tool configured to read a schema definition from the schema registry 416 based on a schema identifier. In some implementations, the schema agent 408 may invoke a tool call that reads from the schema registry 416.

In some implementations, where no candidate schema in the schema registry 416 satisfies a coverage condition with respect to the sample log data, the schema agent 408 may be configured to generate a new schema and to store the new schema in the schema registry 416 for subsequent retrieval. A coverage condition refers to a criterion that evaluates whether a candidate schema adequately represents fields present in the sample log data. Examples of the coverage condition include, but are not limited to, a threshold percentage of fields of the sample log data that are mapped to fields of the candidate schema, a criterion that a field of a specified kind be present in the candidate schema, a similarity-score threshold between a structure of the sample log data and a structure of the candidate schema, and a criterion based on absence of a material field type (e.g., a field type such as a timestamp field, an identifier field, or a severity-level field that is commonly expected in event data of the log type) within the candidate schema.

The pipeline agent 410 (which may also be referred to as a fifth automated agent) may be configured to generate a data pipeline based on a pipeline plan received from the pipeline plan agent 412. The pipeline agent 410 may be, be similar to, include, or be included in an instance of the automated agent 302 shown in FIG. 3, in which the context 304, the prompts 306, the local tools 308, and the LLM provider 310 are configured to support pipeline compilation. In some implementations, the pipeline agent 410 may be configured to compile the pipeline plan into an executable configuration for a data processing engine, where the executable configuration defines an ordered arrangement of data processing functions that transform event data from the data source into records conforming to the schema and deliver the records to a destination. In some implementations, the pipeline agent 410 compiles the pipeline plan into the executable configuration by invoking, through the LLM provider 310, a language model with a pipeline-generation prompt of the kind described with reference to FIG. 5B, the language model producing one or more fragments of the executable configuration as output. In some implementations, the pipeline agent 410 compiles the pipeline plan into the executable configuration by way of a deterministic transducer that maps each data processing function specified in the pipeline plan to a corresponding configuration fragment according to a mapping between function-type identifiers and configuration fragment templates. In some implementations, the pipeline agent 410 compiles the pipeline plan into the executable configuration by way of a hybrid mechanism in which the language model produces a first portion of the executable configuration and the deterministic transducer produces a second portion of the executable configuration, or in which the language model generates a draft of the executable configuration and the deterministic transducer subsequently normalizes or post-processes the draft.

In some implementations, the data processing engine may be, be similar to, include, or be included in the stream platform 110 shown in FIG. 1. In some implementations, the data processing engine may be external to the system 102 shown in FIG. 1. In some implementations, the pipeline agent 410 may include, as one or more of the local tools 308, a regular-expression validator tool configured to test syntactic validity of a regular expression included in the executable configuration, a scripting-language validator tool configured to test syntactic validity of a scripting fragment included in the executable configuration, a context-retrieval tool configured to retrieve contextual information in support of edit-pipeline scenarios in which an existing data pipeline is being modified, or a combination thereof. In some implementations, the data processing functions included in the executable configuration generated by the pipeline agent 410 may include, but are not limited to, a parsing function configured to extract a field from an input event, an enrichment function configured to add information to a record from one or more external sources, a normalization function configured to align field names and field values with conventions of the schema, a redaction function configured to mask or remove a sensitive field value, and a routing function configured to deliver a record to at least one destination. The destinations to which the data pipeline generated by the pipeline agent 410 may deliver records include, but are not limited to, a log analytics system, an object store, a search index, a security information and event management (SIEM) system, and a data lake.

In some implementations, the pipeline agent 410 may further include, as one of the local tools 308, an annotation tool configured to embed, within the executable configuration, one or more comment fragments that hold a natural-language representation of the pipeline plan, one or more portions thereof, or a rationale derived therefrom, where the comment fragments are ignored by the data processing engine during execution of the data pipeline and are retained with the executable configuration across edits, exports, imports, and transfers of the data pipeline.

The pipeline plan agent 412 (which may also be referred to as a fourth automated agent) may be configured to generate a pipeline plan based on the sample log data, the log type, and the schema. The pipeline plan agent 412 may be, be similar to, include, or be included in an instance of the automated agent 302 shown in FIG. 3, in which the context 304, the prompts 306, the local tools 308, and the LLM provider 310 are configured to support pipeline-plan generation.

In some implementations, the pipeline plan agent 412 may be configured to invoke a language model through the LLM provider 310 to produce the pipeline plan as a structured representation, the structured representation specifying a sequence of data processing functions, one or more parameters for each of the data processing functions, and a mapping between fields of the sample log data and fields of the schema. Conformance of the structured representation to a defined schema may be enforced during generation of the structured representation through constrained decoding of the language model. Examples of constrained decoding include, but are not limited to, grammar-constrained decoding, decoding constrained by a schema expressed as a schema for JavaScript Object Notation (JSON), finite-state-machine-driven decoding, and biasing of token-selection logits against tokens that would violate a specified structure.

In some implementations, the pipeline plan agent 412 may be configured to incorporate language-model alignment techniques including constraining outputs of the language model, few-shot prompting in which representative example plans are included in a prompt provided to the language model, chain-of-thought prompting in which the language model is directed to articulate intermediate reasoning steps, or a combination thereof. In some implementations, the pipeline plan generated by the pipeline plan agent 412 may be a natural-language description, a structured representation, a combination thereof, or a mixed representation that includes structured fields and natural-language annotations. In some implementations, the pipeline plan may be editable by a user through the user interface 122 shown in FIG. 1.

The log type registry 414 (which may also be referred to as a log type registry, a log-format catalog, or a log type dataset) may be configured to store a curated catalog of log type definitions that may be consulted by the log type inference agent 406 to identify a log type corresponding to the sample log data. The log type registry 414 may be, be similar to, include, or be included in a set of records held on disk in a format optimized for retrieval. For example, the log type registry 414 may contain on the order of one hundred or more log type definitions spanning many vendors, where a log type definition may include one or more examples of raw events, field names, file structure, or a combination thereof. In some implementations, the log type registry 414 may be extensible, such that an operator of the system 102 shown in FIG. 1 may add a new log type definition to the log type registry 414 over time to extend coverage.

The schema registry 416 (which may also be referred to as a schema catalog or a schema store) may be configured to store a curated catalog of schema definitions that may be consulted by the schema agent 408 to select a schema for transformation of the sample log data. The schema registry 416 may be, be similar to, include, or be included in a set of schema definitions held on disk in a format optimized for retrieval. Examples of schemas stored in the schema registry 416 include, but are not limited to, an Open Cybersecurity Schema Framework (OCSF) schema, an Elastic Common Schema (ECS) schema, a Unified Data Model (UDM) schema, and a custom schema previously saved by an operator or a user of the stream platform 110 shown in FIG. 1. In some implementations, the schema registry 416 may support both read operations and write operations, such that a new schema generated by the schema agent 408 where no candidate schema satisfies a coverage condition with respect to the sample log data may be stored into the schema registry 416 for subsequent retrieval.

In some implementations, the agentic framework architecture including the schematizer agent 404, the log type inference agent 406, the schema agent 408, the pipeline agent 410, the pipeline plan agent 412, the log type registry 414, and the schema registry 416 may be implemented using a supervisor-worker architecture as described above, a mesh architecture in which the schematizer agent 404, the log type inference agent 406, the schema agent 408, the pipeline agent 410, and the pipeline plan agent 412 interoperate on a non-hierarchical basis, a collaborative architecture in which a plurality of automated agents among the schematizer agent 404, the log type inference agent 406, the schema agent 408, the pipeline agent 410, and the pipeline plan agent 412 work on the same task with outputs evaluated to produce a final result, a handoff architecture in which a given automated agent identifies a next automated agent to which a task is to be handed off based on available information regarding specializations of other available automated agents, or a combination thereof. The supervisor-worker architecture, the mesh architecture, the collaborative architecture, and the handoff architecture are further described with reference to FIG. 3. In some implementations, the supervisor-worker architecture is preferred for the log-schematization workflow because the supervisor-worker architecture permits the schematizer agent 404 to validate outputs of the worker automated agents before the outputs are incorporated into the context object, providing a mechanism by which errors in any one worker automated agent may be detected and corrected before the errors propagate to subsequent workers. In some implementations, alternative implementations of the pipeline generation framework architecture 400 may be implemented that include different, additional, or fewer components.

In operation, the schematizer agent 404 receives the sample log data through the frontend 402 and coordinates a sequence of agent invocations that includes invocation of the log type inference agent 406 with the sample log data, receipt of a log type from the log type inference agent 406, invocation of the schema agent 408 with the sample log data and the log type, receipt of a schema from the schema agent 408, invocation of the pipeline plan agent 412 with the sample log data, the log type, and the schema, receipt of a pipeline plan from the pipeline plan agent 412, invocation of the pipeline agent 410 with the pipeline plan and the sample log data, and receipt of a data pipeline from the pipeline agent 410. At each invocation, the frontend 402 transmits a respective request of a plurality of successive requests, the request including the context object maintained by the frontend 402 that reflects one or more prior steps of the log-schematization workflow. The system 102 shown in FIG. 1 does not retain state associated with the log-schematization workflow between the successive requests.

FIG. 5A is a flow diagram of an example of an operational flow 500 of a pipeline generation framework architecture incorporating log schematization. The operational flow 500 may be understood with reference to the components described with reference to FIGS. 1, 3, and 4, including the pipeline generation framework architecture 400, the schematizer agent 404, the log type inference agent 406, the schema agent 408, the pipeline agent 410, the pipeline plan agent 412, the log type registry 414, and the schema registry 416, which may cooperate to perform the operations depicted in FIG. 5A.

At collect input events 502, the operational flow 500 may include aggregating a set of sample log data corresponding to a data source for use as input to subsequent operations of the operational flow 500. The sample log data aggregated at collect input events 502 may include, but is not limited to, a bounded plurality of events drawn from the data source, where the bounded plurality of events is representative of event data produced by the data source. In some implementations, collect input events 502 may be performed at least in part by the schematizer agent 404, by the frontend 402, or by a combination thereof. The collect input events 502 may be preceded by, or may receive input from, any of capture from source 504, select existing sample 506, and copy events into chat 508.

At capture from source 504, the operational flow 500 may include capturing sample log data from a connected data source by transmitting a capture command to the data source and receiving a bounded plurality of events in response. For example, the data source may be, be similar to, include, or be included in a data source accessible through the edge platform 112, the stream platform 110, or the search platform 108 shown in FIG. 1. In some implementations, capture from source 504 may be performed through a capture tool of the frontend 402 invoked by the schematizer agent 404.

At select existing sample 506, the operational flow 500 may include selecting a previously saved sample file as the sample log data for the operational flow 500. For example, the previously saved sample file may be, be similar to, include, or be included in a file previously captured from the data source and saved through a file-save tool of the frontend 402, a file made available from another source, or a combination thereof. In some implementations, select existing sample 506 may be performed through a sample-file-selection tool of the frontend 402 invoked in response to a selection made by a user through the user interface 122 shown in FIG. 1.

At copy events into chat 508, the operational flow 500 may include receiving sample log data as free-form text entered by the user into a text input of the user interface 122 shown in FIG. 1. For example, the user may paste one or more representative events into the text input, which the frontend 402 may forward to the schematizer agent 404 for use as the sample log data. In some implementations, the operational flow 500 may support any combination of capture from source 504, select existing sample 506, and copy events into chat 508 as an ingestion path into collect input events 502.

In some implementations, between the collect input events 502 and the classify log type 510, the operational flow 500 may further include a pre-classification cleanup step configured to prepare the sample log data for classification. The pre-classification cleanup step may include one or more of de-duplicating events that are substantially identical to other events of the sample log data, trimming a length of individual events to a bounded character count, filtering events according to one or more filter criteria, and redacting or masking field values of a sensitive kind within events of the sample log data. In some implementations, the pre-classification cleanup step may be performed by one or more pre-cleanup tools invoked by the schematizer agent 404, or by the user through one or more selectable input elements of the user interface 122 shown in FIG. 1. The output of the pre-classification cleanup step may replace the sample log data for subsequent steps of the operational flow 500.

At classify log type 510, the operational flow 500 may include inferring a log type based on the sample log data utilizing the log type inference agent 406 and the log type registry 414. For example, the log type inference agent 406 may retrieve a plurality of candidate log type definitions from the log type registry 414, invoke a language model with the sample log data and the candidate log type definitions as input, and return the log type selected from among the candidate log type definitions. In some implementations, the retrieval of the candidate log type definitions may be based on a similarity measure computed between a representation of the sample log data and representations of entries in the log type registry 414. In some implementations, where no entry in the log type registry 414 corresponds to the sample log data, the classify log type 510 may output a sentinel indicating an unknown log type.

At user objective 512, the operational flow 500 may include obtaining a set of one or more objectives from the user with respect to the sample log data. The user objective 512 may receive input from any of apply transformations 514, convert to target schema 516, and filter down events 518. In some implementations, the user objective 512 may be received through the user interface 122 shown in FIG. 1 by way of selection of one or more selectable input elements corresponding to objectives of the user.

At apply transformations 514, the operational flow 500 may include receiving, as an objective of the user, an indication that the sample log data is to be transformed from one representation to another representation. For example, the transformation may include modification of field names, modification of field values, derivation of additional fields, or a combination thereof. The indication received at apply transformations 514 may be provided to the user objective 512.

At convert to target schema 516, the operational flow 500 may include receiving, as an objective of the user, an indication that the sample log data is to be transformed into records conforming to a target schema. For example, the target schema may include an Open Cybersecurity Schema Framework (OCSF) schema, an Elastic Common Schema (ECS) schema, a Unified Data Model (UDM) schema, a customer-provided schema, or a combination thereof. The indication received at convert to target schema 516 may be provided to the user objective 512.

At filter down events 518, the operational flow 500 may include receiving, as an objective of the user, an indication that the sample log data is to be reduced to a subset of events of interest. For example, the subset may be identified by one or more filter expressions applied by a data processing function of a data pipeline. The indication received at filter down events 518 may be provided to the user objective 512.

At recommend target schema 520, the operational flow 500 may include selecting a schema from the schema registry 416 based on the sample log data and the log type, utilizing the schema agent 408. For example, the schema agent 408 may retrieve a plurality of candidate schemas associated with the log type from the schema registry 416 and may invoke a language model with the sample log data, the log type, and the candidate schemas as input, such that the schema selected by the schema agent 408 is selected from among the candidate schemas. In some implementations, the recommend target schema 520 may be performed conditionally based on the objective obtained at user objective 512, such that the recommend target schema 520 may be performed where the objective includes conversion to a target schema and may be bypassed where the objective does not include conversion to a target schema. In some implementations, where no candidate schema in the schema registry 416 satisfies a coverage condition with respect to the sample log data, the recommend target schema 520 may include generating a new schema and storing the new schema in the schema registry 416.

At generate pipeline plan 522, the operational flow 500 may include generating a pipeline plan based on the sample log data, the log type, and the schema, utilizing the pipeline plan agent 412. For example, the pipeline plan agent 412 may invoke a language model to produce the pipeline plan as a structured representation specifying a sequence of data processing functions, one or more parameters for each of the data processing functions, and a mapping between fields of the sample log data and fields of the schema. In some implementations, the structured representation may be produced through constrained decoding of the language model, few-shot prompting, chain-of-thought prompting, or a combination thereof. In some implementations, the pipeline plan may be presented to the user through the user interface 122 shown in FIG. 1 for review or editing prior to proceeding to generate pipeline 524.

At generate pipeline 524, the operational flow 500 may include generating a data pipeline based on the pipeline plan, utilizing the pipeline agent 410. The generate pipeline 524 may include compiling the pipeline plan into an executable configuration for a data processing engine, where the executable configuration defines an ordered arrangement of data processing functions configured to transform event data from the data source into records conforming to the schema and to deliver the records to a destination. An example of prompt assembly at generate pipeline 524 is described further with reference to FIG. 5B. In some implementations, the generate pipeline 524 may receive an additional input from prior pipeline 526 where an existing data pipeline is to be modified rather than a new data pipeline generated. In some implementations, the generate pipeline 524 may include writing, into a comment section of the executable configuration, a natural-language representation of the pipeline plan, one or more portions thereof, or a rationale derived therefrom, such that design rationale expressed in the pipeline plan is retained with the executable configuration across subsequent edits, exports, or imports of the data pipeline.

At prior pipeline 526, the operational flow 500 may include providing, as an additional input to generate pipeline 524, a representation of a previously generated data pipeline. For example, the prior pipeline 526 may be provided where the user wishes to modify or extend an existing data pipeline, and the operational flow 500 may select one or more few-shot examples from an example registry of FIG. 5B based at least in part on the prior pipeline 526.

At validate regex 528, the operational flow 500 may include testing a syntactic validity of one or more regular expressions included in the executable configuration produced by generate pipeline 524. For example, the pipeline agent 410 may include a regular-expression validator tool among the local tools 308 of the pipeline agent 410. In some implementations, where a regular expression included in the executable configuration fails validation, the pipeline agent 410 may modify the executable configuration, may request a modified pipeline plan from the pipeline plan agent 412, or may take another suitable action.

At validate JavaScript 530, the operational flow 500 may include testing a syntactic validity of one or more scripting fragments included in the executable configuration produced by generate pipeline 524. For example, the pipeline agent 410 may include a scripting-language validator tool among the local tools 308 of the pipeline agent 410. In some implementations, where a scripting fragment included in the executable configuration fails validation, the pipeline agent 410 may modify the executable configuration, may request a modified pipeline plan from the pipeline plan agent 412, or may take another suitable action.

At deploy pipeline 532, the operational flow 500 may include committing the data pipeline to a data processing engine for processing data from the data source. For example, the data pipeline may be deployed to the stream platform 110 shown in FIG. 1 and may be registered with a route of the stream platform 110 that corresponds to the data source. In some implementations, the deploy pipeline 532 may be conditional upon the data pipeline being applied to at least a portion of the sample log data and an output of the data pipeline being compared to the schema to produce a validation result, where the data pipeline is committed for use in processing data from the data source conditioned on the validation result. In some implementations, the deploy pipeline 532 may include receiving, through the user interface 122 shown in FIG. 1, a user-specified pipeline name for the data pipeline, such that the data pipeline is registered with the stream platform 110 shown in FIG. 1 under the user-specified pipeline name. In some implementations, where no user-specified pipeline name is received, the deploy pipeline 532 may include assigning an automatically generated pipeline name derived from one or more of the log type, the schema, an identifier of the data source, and a timestamp of the log-schematization workflow.

In some implementations, the operational flow 500 may support iteration, such that where the recommend target schema 520, the generate pipeline plan 522, the generate pipeline 524, the validate regex 528, the validate JavaScript 530, or the deploy pipeline 532 produces an output that is not accepted by the user or that fails one or more validators, control may return to an earlier operation of the operational flow 500 for modification. For example, control may return to the collect input events 502, the classify log type 510, the user objective 512, the recommend target schema 520, the generate pipeline plan 522, or the generate pipeline 524, depending on where the issue was identified.

In operation, the operational flow 500 transforms the sample log data from an ingestion path through a classify log type 510, a user objective 512, a recommend target schema 520 conditioned on the objective, a generate pipeline plan 522, a generate pipeline 524 with optional input from a prior pipeline 526, a validate regex 528 and a validate JavaScript 530, and a deploy pipeline 532, producing a data pipeline configured to transform event data from the data source into records conforming to the schema and to deliver the records to a destination.

FIG. 5B is a data flow diagram of an example of pipeline-generation prompt assembly for a pipeline agent. The pipeline-generation prompt assembly depicted in FIG. 5B may be understood with reference to the components described with reference to FIGS. 1, 3, 4, and 5A. The pipeline-generation prompt assembly depicted in FIG. 5B may be performed at the generate pipeline 524 of the operational flow 500 shown in FIG. 5A by the pipeline agent 410 shown in FIG. 4, using a language model 562 invoked through an LLM provider 310 of the type described with reference to FIG. 3.

A pipeline generation prompt 534 (which may also be referred to as an assembled prompt or a pipeline-agent prompt) may be configured to provide a combination of input data and reference data to the language model 562 for generation of an executable configuration of the data pipeline. The pipeline generation prompt 534 may be, be similar to, include, or be included in a data structure assembled by the pipeline agent 410 prior to invocation of the language model 562, where the pipeline generation prompt 534 incorporates a set of inputs drawn from the sample log data, the pipeline plan, one or more function-type definitions, and one or more few-shot examples.

Input events 536 (which may also be referred to as sample log data) may be provided to the pipeline generation prompt 534 as a representative set of event data drawn from the data source. The input events 536 may be, be similar to, include, or be included in the sample log data aggregated at the collect input events 502 of the operational flow 500 shown in FIG. 5A. In some implementations, the input events 536 may include on the order of a small bounded plurality of events drawn from the data source that are representative of the event data produced by the data source.

A pipeline plan 538 may be provided to the pipeline generation prompt 534 as a description of transformations to apply to the input events 536 in order to produce records conforming to a schema. The pipeline plan 538 may be, be similar to, include, or be included in the pipeline plan generated at the generate pipeline plan 522 of the operational flow 500 shown in FIG. 5A by the pipeline plan agent 412 shown in FIG. 4. In some implementations, the pipeline plan 538 may include a structured representation specifying a sequence of data processing functions, one or more parameters for each of the data processing functions, and a mapping between fields of the input events 536 and fields of the schema.

A set of definitions 540 may be incorporated into the pipeline generation prompt 534. The definitions 540 may be, be similar to, include, or be included in one or more descriptions of data processing functions available to the pipeline agent 410 for inclusion in the executable configuration. Examples of the definitions 540 include, but are not limited to, an eval definition corresponding to an eval function type 548, a regex-extract definition corresponding to a regex extract function type 550, a mask definition corresponding to a mask function type 552, and one or more additional function-type definitions retrieved from a function type registry 546.

A first example ex2: vpc-flow-1 542 (which may also be referred to as a virtual-private-cloud flow-log example) may be selected for inclusion in the pipeline generation prompt 534 as a few-shot example. The ex2: vpc-flow-1 542 may be, be similar to, include, or be included in a worked example including a representative set of virtual-private-cloud flow log events and a corresponding executable configuration that is known to produce records conforming to a related schema. The ex2: vpc-flow-1 542 may be retrieved from an example registry 558.

A second example ex3: edit-pipeline 544 may be selected for inclusion in the pipeline generation prompt 534 as a few-shot example directed to modification of an existing data pipeline. The ex3: edit-pipeline 544 may be, be similar to, include, or be included in a worked example including a representative existing executable configuration, a set of input events to which the existing executable configuration is applied, and a modified executable configuration that addresses a modification objective. The ex3: edit-pipeline 544 may be retrieved from the example registry 558.

The function type registry 546 (which may also be referred to as a function catalog) may be configured to store descriptions of data processing functions supported by the data processing engine. The function type registry 546 may be, be similar to, include, or be included in a set of records held on disk or in memory and accessible to the pipeline agent 410 through a retrieval tool. In some implementations, the function type registry 546 may be extensible, such that an operator of the system 102 shown in FIG. 1 may add a definition of a new function type to the function type registry 546 over time to extend coverage.

The eval function type 548 may be stored within the function type registry 546. The eval function type 548 may be, be similar to, include, or be included in a function-type definition describing a data processing function that computes a derived field from one or more input fields of an event. For example, the eval function type 548 may be included, where selected for the executable configuration, as a data processing function that evaluates an arithmetic expression, a string operation, a type coercion, or a combination thereof, to produce a derived field.

The regex extract function type 550 may be stored within the function type registry 546. The regex extract function type 550 may be, be similar to, include, or be included in a function-type definition describing a data processing function that extracts one or more fields from an input by applying a regular expression. For example, the regex extract function type 550 may correspond to a parsing function of a data pipeline configured to extract a structured field from an unstructured portion of an input event.

The mask function type 552 may be stored within the function type registry 546. The mask function type 552 may be, be similar to, include, or be included in a function-type definition describing a data processing function that masks, redacts, or removes a field value from an event. For example, the mask function type 552 may correspond to a redaction function of a data pipeline configured to remove or obscure sensitive data such as a personally-identifying-information (PII) value, a credential value, a health-record value, or a combination thereof.

A detected log type 554 may be provided as an input that influences selection of one or more few-shot examples from the example registry 558. The detected log type 554 may be, be similar to, include, or be included in the log type selected by the log type inference agent 406 at the classify log type 510 of the operational flow 500 shown in FIG. 5A. In some implementations, the example registry 558 may be queried, based on the detected log type 554, for one or more few-shot examples that correspond to the detected log type 554 or to a family of log types that includes the detected log type 554.

A prior pipeline data 556 may be provided as a further input that influences selection of one or more few-shot examples from the example registry 558. The prior pipeline data 556 may be, be similar to, include, or be included in the prior pipeline 526 of the operational flow 500 shown in FIG. 5A. In some implementations, where the prior pipeline data 556 is provided, the example registry 558 may be queried for one or more few-shot examples directed to modification of an existing executable configuration, such as the ex3: edit-pipeline 544.

The example registry 558 (which may also be referred to as a few-shot registry or a worked-example catalog) may be configured to store worked examples of pipeline generation for use as few-shot references in the pipeline generation prompt 534. The example registry 558 may be, be similar to, include, or be included in a set of records held on disk or in memory and accessible to the pipeline agent 410 through a retrieval tool. In some implementations, the example registry 558 may be extensible, such that an operator of the system 102 shown in FIG. 1 may add a new worked example to the example registry 558 over time to extend coverage.

A third example ex1: cisco-asa-1 560 may be stored within the example registry 558. The ex1: cisco-asa-1 560 may be, be similar to, include, or be included in a worked example including a representative set of firewall-appliance log events and a corresponding executable configuration known to produce records conforming to a related schema. In some implementations, the ex1: cisco-asa-1 560 may be selected for inclusion in the pipeline generation prompt 534 where the detected log type 554 corresponds to a firewall-appliance log format.

The language model 562 may be configured to receive the pipeline generation prompt 534 and to produce output from which the executable configuration of the data pipeline may be derived. The language model 562 may be, be similar to, include, or be included in a language model invoked through the LLM provider 310 shown in FIG. 3, and may be included in or accessible through the ML component 118 shown in FIG. 1. In some implementations, the language model 562 may be selected for invocation from a plurality of language models based on a characteristic of the input events 536, on a computational budget associated with a request, or on a combination thereof.

In operation, the input events 536 and the pipeline plan 538 are provided to the pipeline generation prompt 534 as primary inputs. One or more function-type definitions are retrieved from the function type registry 546 and provided as the definitions 540 to the pipeline generation prompt 534. The detected log type 554 and the prior pipeline data 556 are provided as selection inputs to the example registry 558, which produces one or more few-shot examples such as the ex2: vpc-flow-1 542 and the ex3: edit-pipeline 544 for inclusion in the pipeline generation prompt 534. The assembled pipeline generation prompt 534 is provided to the language model 562 which produces output from which the executable configuration of the data pipeline is derived. Through this arrangement, the pipeline agent 410 grounds output of the language model 562 in known-good function-type definitions retrieved from the function type registry 546 and in representative worked examples retrieved from the example registry 558, providing a mechanism by which the pipeline agent 410 may reduce hallucinations by the language model 562 and may produce an executable configuration that is compatible with the data processing engine.

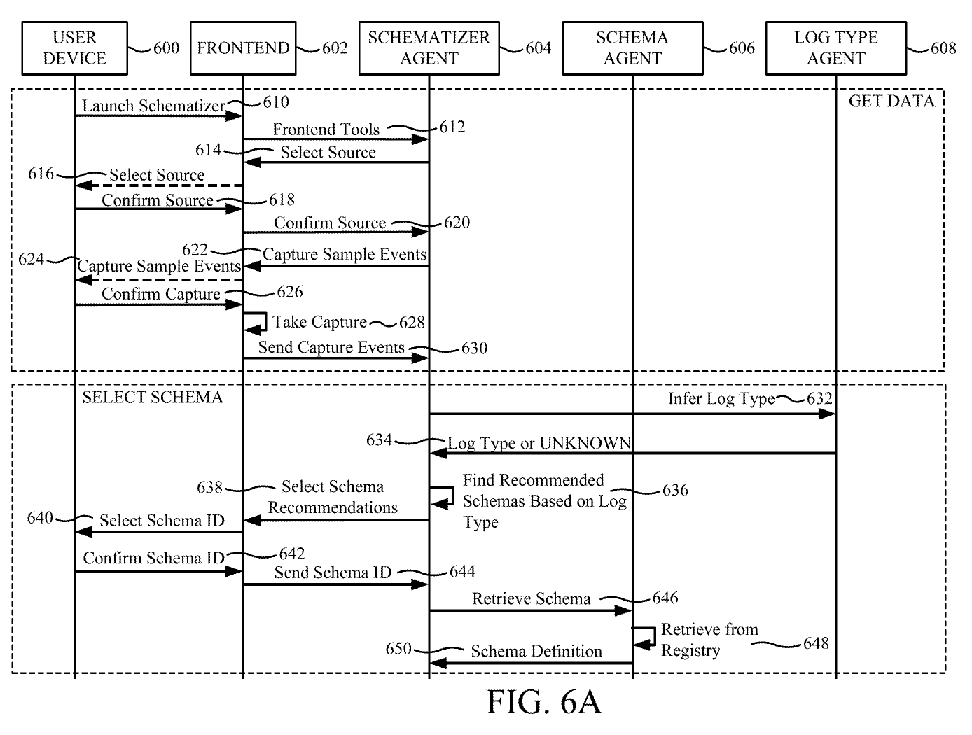

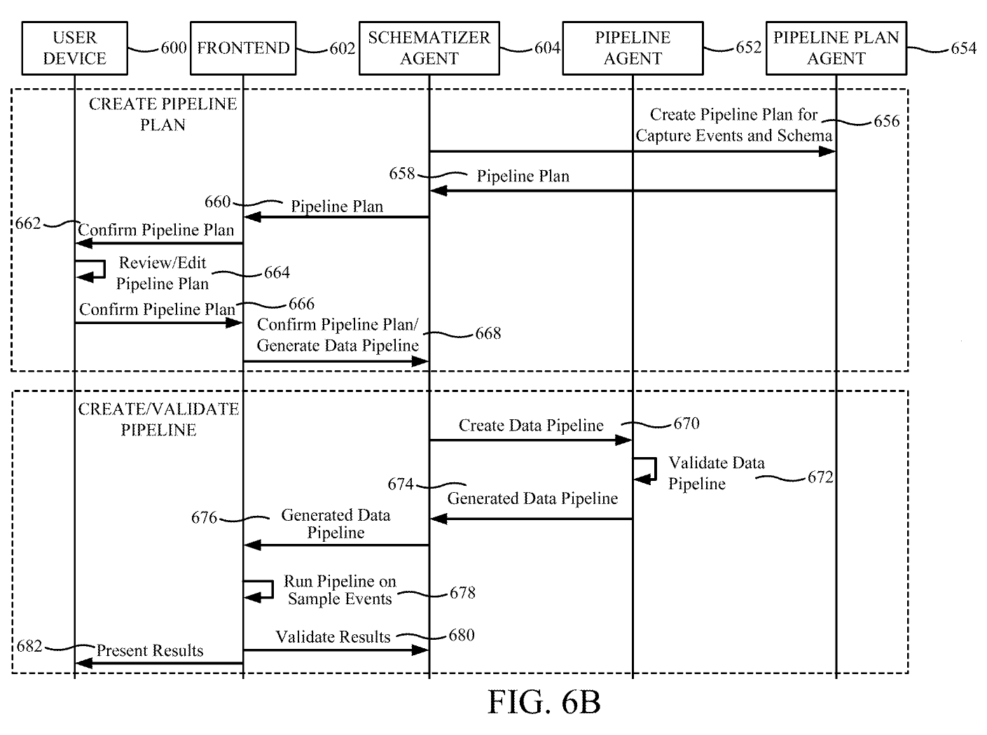

FIG. 6A is a sequence diagram of example interactions among a user device, a frontend, a schematizer agent, a schema agent, and a log type agent during data collection and schema selection phases of pipeline generation. The sequence diagram depicted in FIG. 6A may be understood with reference to the components described with reference to FIGS. 1, 3, 4, and 5A, and depicts a plurality of successive requests transmitted from a client side to a server side of a system 102 shown in FIG. 1, each of the successive requests including a context object maintained by the client side that reflects one or more prior steps of the log-schematization workflow, where the system 102 does not retain state associated with the log-schematization workflow between the successive requests.

A user device 600 (which may also be referred to as a client-side device) may be, be similar to, include, or be included in the user device 104 shown in FIG. 1. The user device 600 represents a lifeline associated with actions originated by a user during the depicted interactions, and may include rendering of the user interface 122 of the client 120 shown in FIG. 1.

A frontend 602 (which may also be referred to as a client-side orchestrator) may be, be similar to, include, or be included in the frontend 402 shown in FIG. 4 or a component thereof, and may be executed by the client 120 of the user device 104 shown in FIG. 1. The frontend 602 represents a lifeline associated with actions performed by the client-side orchestrator that mediates between the user device 600 and server-side automated agents during the depicted interactions.

A schematizer agent 604 (which may also be referred to as a first automated agent) may be, be similar to, include, or be included in the schematizer agent 404 shown in FIG. 4. The schematizer agent 604 represents a lifeline associated with server-side actions performed by the schematizer agent in response to requests received from the frontend 602.

A schema agent 606 (which may also be referred to as a third automated agent) may be, be similar to, include, or be included in the schema agent 408 shown in FIG. 4. The schema agent 606 represents a lifeline associated with server-side actions performed by the schema agent in response to delegations received from the schematizer agent 604.

A log type agent 608 (which may also be referred to as a second automated agent or a log type agent) may be, be similar to, include, or be included in the log type inference agent 406 shown in FIG. 4. The log type agent 608 represents a lifeline associated with server-side actions performed by the log type agent in response to delegations received from the schematizer agent 604.

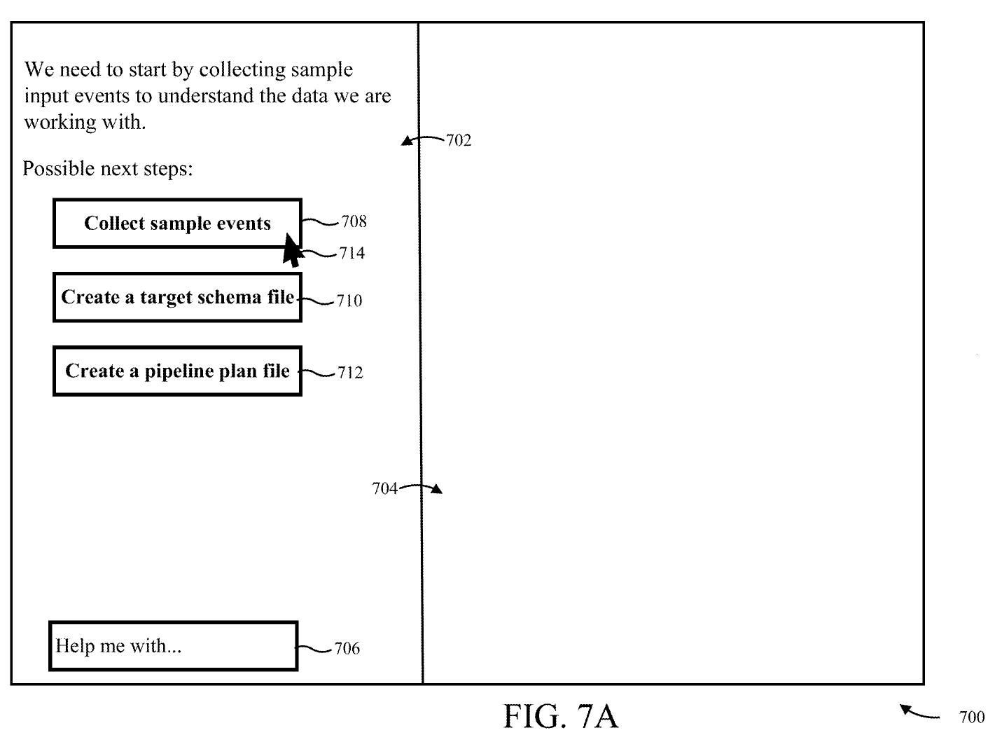

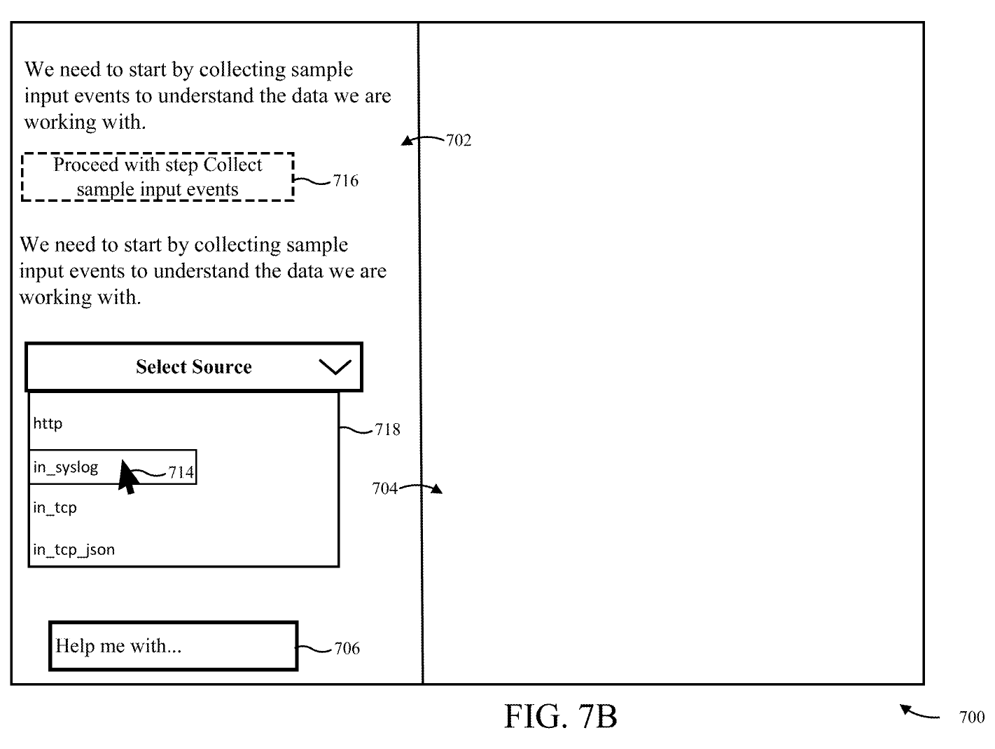

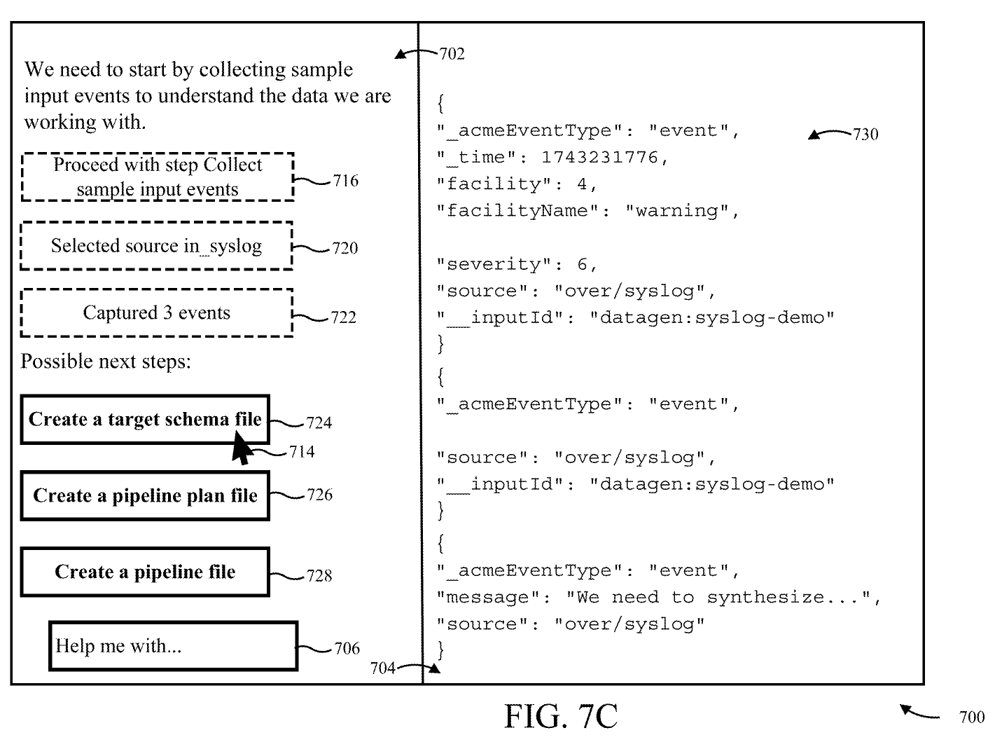

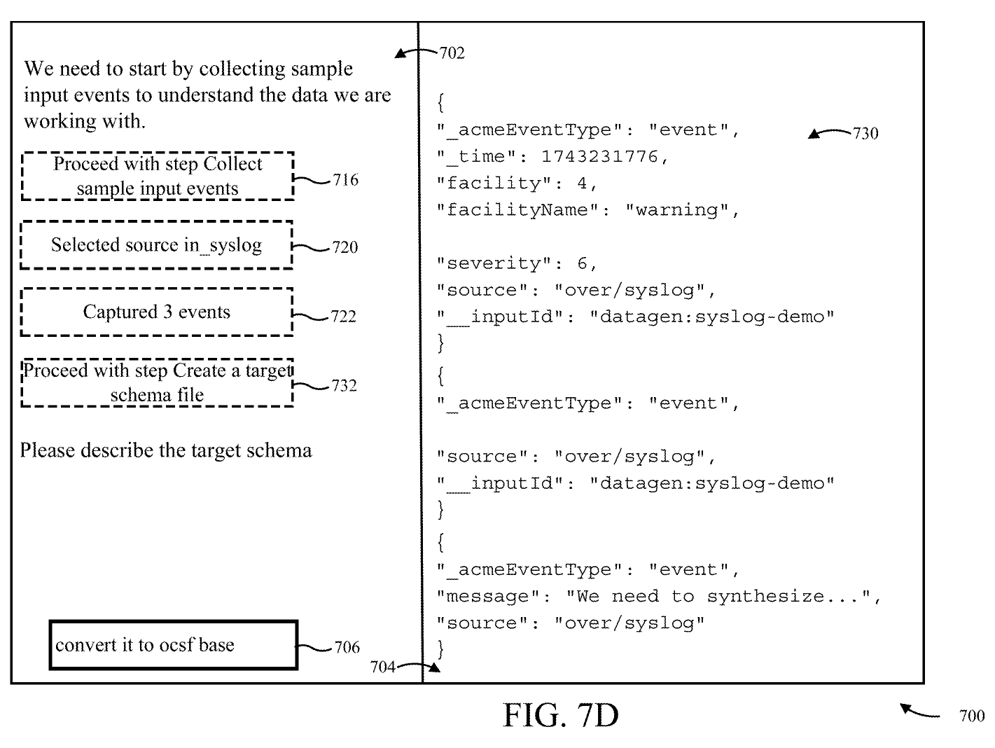

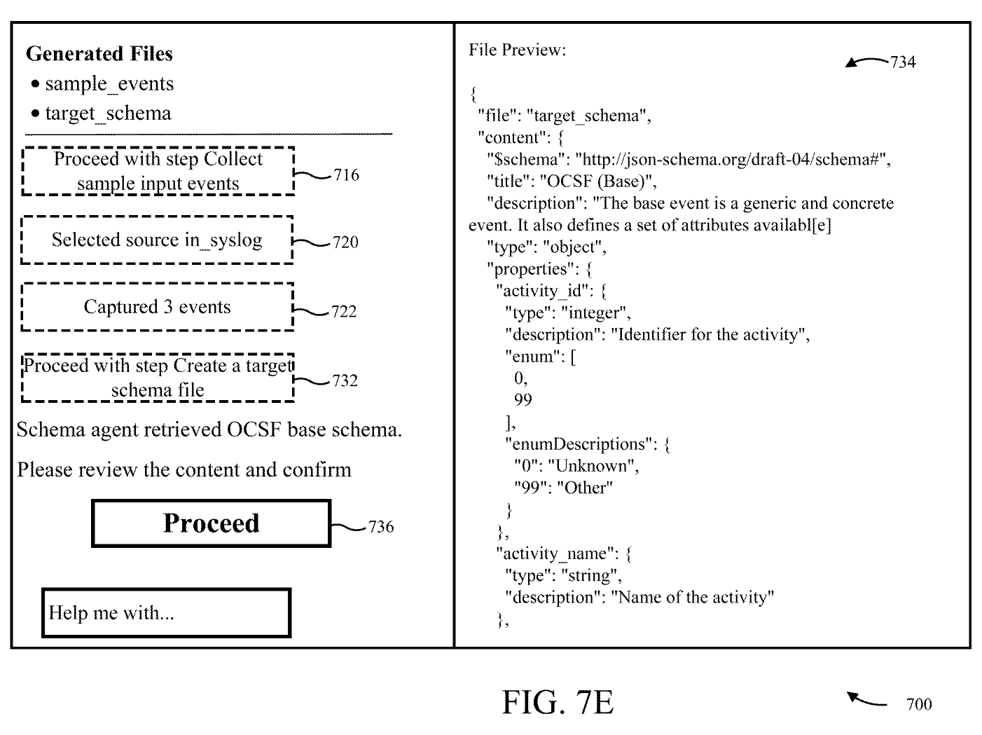

A launch schematizer 610 interaction is transmitted from the user device 600 to the frontend 602 to initiate the log-schematization workflow. For example, the launch schematizer 610 may be initiated by a user entering a command in a chat input of the user interface 122 shown in FIG. 1 or by the user selecting a selectable input element corresponding to launching the schematizer, as further described with reference to FIG. 7A.

A frontend tools 612 interaction is transmitted from the frontend 602 to the schematizer agent 604 to provide a set of client-side tools available to the schematizer agent 604 for invocation during the log-schematization workflow.

A select source 614 interaction is transmitted from the schematizer agent 604 to the frontend 602 to request that a data source be identified for the log-schematization workflow. A select source 616 interaction is transmitted from the frontend 602 to the user device 600 to prompt the user to select the data source through the user interface 122 shown in FIG. 1.

A confirm source 618 interaction is transmitted from the user device 600 to the frontend 602 to indicate selection of the data source by the user. A confirm source 620 interaction is transmitted from the frontend 602 to the schematizer agent 604 to provide an identifier of the data source, which may be written into the context object by the frontend 602 prior to transmission of a next request of the successive requests.

A capture sample events 622 interaction is transmitted from the schematizer agent 604 to the frontend 602 to request capture of sample log data from the data source. A capture sample events 624 interaction is transmitted from the frontend 602 to the user device 600 to prompt the user to confirm the capture.

A confirm capture 626 interaction is transmitted from the user device 600 to the frontend 602 to indicate confirmation by the user. A take capture 628 interaction is performed internally by the frontend 602 to capture a bounded plurality of events from the data source and to prepare the sample log data for transmission to the schematizer agent 604.

A send capture events 630 interaction is transmitted from the frontend 602 to the schematizer agent 604 to provide the sample log data to the schematizer agent 604 for use in subsequent operations of the log-schematization workflow, or to provide a reference to the sample log data where the sample log data is held by reference rather than by value. Upon receipt of the send capture events 630 interaction, the schematizer agent 604 invokes a language model through the LLM provider 310 shown in FIG. 3 to characterize a format of the sample log data and returns a schematization result to the frontend 602. The frontend 602 writes the schematization result into the context object prior to transmission of a next request of the successive requests.

An infer log type 632 interaction is transmitted from the schematizer agent 604 to the log type agent 608 to delegate inference of a log type based on the sample log data. The log type agent 608 consults the log type registry 414 shown in FIG. 4, which may include retrieval of a plurality of candidate log type definitions from the log type registry 414 based on a similarity measure computed between a representation of the sample log data and representations of entries in the log type registry 414, and invokes a language model with the sample log data and the candidate log type definitions as input.

A log type or UNKNOWN 634 interaction is transmitted from the log type agent 608 to the schematizer agent 604, and may include the log type selected from among the candidate log type definitions or a sentinel indicating an unknown log type where no candidate log type definition corresponds to the sample log data. The log type, or the sentinel, may be written into the context object by the frontend 602 prior to transmission of a next request of the successive requests.

A find recommended schemas based on log type 636 interaction is performed internally by the schematizer agent 604 to identify one or more candidate schemas that are appropriate for the log type. In some implementations, the find recommended schemas based on log type 636 may include consulting the schema registry 416 shown in FIG. 4 through a server-side tool such as a schema-recommendation tool to obtain the candidate schemas.

A select schema recommendations 638 interaction is transmitted from the schematizer agent 604 to the frontend 602 to deliver the candidate schemas for presentation to the user. A select schema ID 640 interaction is transmitted from the frontend 602 to the user device 600 to prompt the user to select a schema identifier corresponding to a schema to be used for transformation of the sample log data. A confirm schema ID 642 interaction is transmitted from the user device 600 to the frontend 602 to indicate selection of the schema identifier by the user. A send schema ID 644 interaction is transmitted from the frontend 602 to the schematizer agent 604 to provide the schema identifier to the schematizer agent 604.

A retrieve schema 646 interaction is transmitted from the schematizer agent 604 to the schema agent 606 to delegate retrieval of a schema corresponding to the schema identifier. A retrieve from registry 648 interaction is performed internally by the schema agent 606, where the schema agent 606 reads the schema definition from the schema registry 416 shown in FIG. 4 through a schema-retrieval tool among the local tools 308 of the schema agent 606. The retrieve from registry 648 may include at least one tool call that reads from the schema registry 416.

A schema definition 650 interaction is transmitted from the schema agent 606 to the schematizer agent 604 to provide the schema definition corresponding to the schema identifier, which may be written into the context object by the frontend 602 prior to transmission of a next request of the successive requests. The interactions depicted in FIG. 6A may be followed by the interactions depicted in FIG. 6B, which depict a pipeline-plan creation phase and a pipeline creation and validation phase of the log-schematization workflow.

In some implementations, each interaction directed from the frontend 602 to the schematizer agent 604, the schematizer agent 604 to the schema agent 606, or the schematizer agent 604 to the log type agent 608 may be transmitted as a respective request of a plurality of successive requests, each of the successive requests including a context object maintained by the frontend 602 that reflects one or more prior steps of the log-schematization workflow. In some implementations, each of the successive requests may be transmitted across the network 106 shown in FIG. 1 using a stateless application-layer protocol such as the hypertext transfer protocol (HTTP) or a variant thereof. In some implementations, the system 102 shown in FIG. 1 does not use a session identifier to associate any of the successive requests with any other of the successive requests. In some implementations, each of the successive requests may be independently authenticated and independently authorized by the system 102, and the system 102 may validate a signature of the context object in each of the successive requests.

FIG. 6B is a sequence diagram of example interactions among a user device, a frontend, a schematizer agent, a pipeline agent, and a pipeline plan agent during pipeline plan creation and pipeline creation/validation phases of pipeline generation. The sequence diagram depicted in FIG. 6B may be understood with reference to the components described with reference to FIGS. 1, 3, 4, 5A, 5B, and 6A. The interactions depicted in FIG. 6B may follow the interactions depicted in FIG. 6A, such that the user device 600, the frontend 602, and the schematizer agent 604 shown in FIG. 6A continue to participate in the log-schematization workflow in FIG. 6B.

The user device 600, the frontend 602, and the schematizer agent 604 shown in FIG. 6A continue to serve as lifelines within FIG. 6B. The user device 600 represents a lifeline associated with actions originated by a user. The frontend 602 represents a lifeline associated with actions performed by the client-side orchestrator that mediates between the user device 600 and the server-side automated agents. The schematizer agent 604 represents a lifeline associated with server-side actions performed by the schematizer agent, and may be, be similar to, include, or be included in the schematizer agent 404 shown in FIG. 4.

A pipeline agent 652 (which may also be referred to as a fifth automated agent) may be, be similar to, include, or be included in the pipeline agent 410 shown in FIG. 4. The pipeline agent 652 represents a lifeline associated with server-side actions performed by the pipeline agent to compile a pipeline plan into an executable configuration of a data pipeline.

A pipeline plan agent 654 (which may also be referred to as a fourth automated agent) may be, be similar to, include, or be included in the pipeline plan agent 412 shown in FIG. 4. The pipeline plan agent 654 represents a lifeline associated with server-side actions performed by the pipeline plan agent to generate a pipeline plan.

A create pipeline plan for capture events and schema 656 interaction is transmitted from the schematizer agent 604 to the pipeline plan agent 654 to delegate generation of the pipeline plan based on the sample log data, the log type, and the schema. Upon receipt of the create pipeline plan for capture events and schema 656, the pipeline plan agent 654 invokes a language model through the LLM provider 310 shown in FIG. 3 to produce the pipeline plan as a structured representation specifying a sequence of data processing functions, one or more parameters for each of the data processing functions, and a mapping between fields of the sample log data and fields of the schema. In some implementations, the pipeline plan agent 654 may use constrained decoding of the language model to enforce conformance of the structured representation to a defined schema during generation of the pipeline plan.

A pipeline plan 658 interaction is transmitted from the pipeline plan agent 654 to the schematizer agent 604 to return the generated pipeline plan. A pipeline plan 660 interaction is transmitted from the schematizer agent 604 to the frontend 602 to deliver the pipeline plan for presentation to the user. The pipeline plan may be written into the context object by the frontend 602 prior to transmission of a next request of the successive requests.

A confirm pipeline plan 662 interaction is transmitted from the frontend 602 to the user device 600 to prompt the user to review the pipeline plan. A review/edit pipeline plan 664 interaction is performed internally by the user device 600 as the user reviews and, in some implementations, edits the pipeline plan through the user interface 122 shown in FIG. 1. In some implementations, the user may edit the structured representation of the pipeline plan directly through the user interface 122. In some implementations, the user may provide instructions to the pipeline plan agent 654 through a chat input of the user interface 122 to request a modification of the pipeline plan, and the pipeline plan agent 654 may be reinvoked with the instructions to produce an updated pipeline plan.

A confirm pipeline plan 666 interaction is transmitted from the user device 600 to the frontend 602 to indicate confirmation of the pipeline plan by the user. A confirm pipeline plan / generate data pipeline 668 interaction is transmitted from the frontend 602 to the schematizer agent 604 to indicate that the pipeline plan has been confirmed and to request generation of the data pipeline.

A create data pipeline 670 interaction is transmitted from the schematizer agent 604 to the pipeline agent 652 to delegate generation of the data pipeline based on the pipeline plan. The create data pipeline 670 may include providing the pipeline plan, the sample log data or a reference thereto, and optionally a prior data pipeline or a reference thereto, to the pipeline agent 652. Upon receipt of the create data pipeline 670, the pipeline agent 652 assembles a pipeline generation prompt according to FIG. 5B and invokes a language model to produce output from which an executable configuration of the data pipeline is derived.

A validate data pipeline 672 interaction is performed internally by the pipeline agent 652 to test validity of the executable configuration prior to returning the executable configuration to the schematizer agent 604. The validate data pipeline 672 may include invoking a regular-expression validator tool to test syntactic validity of one or more regular expressions included in the executable configuration, invoking a scripting-language validator tool to test syntactic validity of one or more scripting fragments included in the executable configuration, or a combination thereof. In some implementations, where a validator tool identifies a failure, the pipeline agent 652 may modify the executable configuration, may iterate with the language model, or may take another suitable action prior to returning the executable configuration.

A generated data pipeline 674 interaction is transmitted from the pipeline agent 652 to the schematizer agent 604 to return the executable configuration of the data pipeline. A generated data pipeline 676 interaction is transmitted from the schematizer agent 604 to the frontend 602 to deliver the executable configuration for application to the sample log data and for review by the user. The executable configuration may be written into the context object by the frontend 602 prior to transmission of a next request of the successive requests.

A run pipeline on sample events 678 interaction is performed internally by the frontend 602 to apply the data pipeline to at least a portion of the sample log data, producing an output of the data pipeline. The run pipeline on sample events 678 may be performed within the frontend 602 or within the stream platform 110 shown in FIG. 1 under direction of the frontend 602.

A validate results 680 interaction is transmitted from the frontend 602 to the schematizer agent 604 to evaluate whether the output of the data pipeline conforms to the schema. The validate results 680 may include comparing the output of the data pipeline to the schema through a field-by-field conformance check, through a similarity measure between the structure of the output and the structure of the schema, or through a combination thereof. In some implementations, the data pipeline may be committed for processing of data from the data source conditioned on a result of the validate results 680, such that where the result of the validate results 680 indicates that the output of the data pipeline conforms to the schema, the data pipeline is committed to the data processing engine for processing of data from the data source, and where the result of the validate results 680 indicates that the output of the data pipeline does not conform to the schema, control may return to an earlier operation of the log-schematization workflow for modification of the data pipeline, the pipeline plan, or the schema selection.

A present results 682 interaction is transmitted from the frontend 602 to the user device 600 to deliver the output of the data pipeline and the result of the validate results 680 to the user for review. In some implementations, the present results 682 may include presentation of a diff view comparing a raw input event to a corresponding output record produced by the data pipeline, providing a mechanism by which the user may confirm that the data pipeline produces records conforming to the schema prior to committing the data pipeline for processing of data from the data source.

In some implementations, each interaction directed from the frontend 602 to the schematizer agent 604, the schematizer agent 604 to the pipeline agent 652, or the schematizer agent 604 to the pipeline plan agent 654 may be transmitted as a respective request of a plurality of successive requests, each of the successive requests including the context object maintained by the frontend 602 that reflects one or more prior steps of the log-schematization workflow. In some implementations, each of the successive requests may be transmitted using a stateless application-layer protocol such as the hypertext transfer protocol (HTTP) or a variant thereof, the system 102 shown in FIG. 1 may not use a session identifier to associate any of the successive requests with any other of the successive requests, each of the successive requests may be independently authenticated and independently authorized by the system 102, and the system 102 may validate a signature of the context object in each of the successive requests. In some implementations, the system 102 does not retain state associated with the log-schematization workflow between the successive requests depicted in FIGS. 6A and 6B.

FIG. 7A is an example user interface of a pipeline generation framework architecture. The example user interface depicted in FIG. 7A may correspond to the user interface 122 of the client 120 shown in FIG. 1, and may be rendered by the frontend 402 shown in FIG. 4 on the user device 104 shown in FIG. 1 to facilitate interaction between a user and the schematizer agent 404 shown in FIG. 4.

A graphical user interface 700 (which may also be referred to as a GUI) may be configured to facilitate interactive log schematization between the user and the schematizer agent 404. The graphical user interface 700 may be, be similar to, include, or be included in the user interface 122 shown in FIG. 1. The graphical user interface 700 may be rendered, for example, within a browser executing on the user device 104, within a desktop application executing on the user device 104, within a mobile application executing on the user device 104, or a combination thereof.

A chat pane 702 (which may also be referred to as a conversational pane or a chat region) may be configured to display conversational history between the user and the schematizer agent 404 and to accept input from the user. The chat pane 702 may be, be similar to, include, or be included in a scrollable region of the graphical user interface 700 positioned on a left side of the graphical user interface 700. In some implementations, the chat pane 702 may display natural-language output received from the schematizer agent 404, a set of progress indicators reflecting state of the log-schematization workflow, one or more selectable input elements corresponding to suggested next steps, and a text input box for free-form input.

An editor pane 704 (which may also be referred to as a preview pane or a content pane) may be configured to display content associated with the log-schematization workflow, such as sample log data, a schema definition, a pipeline plan, an executable configuration of a data pipeline, and an output of the data pipeline produced for review by the user. The editor pane 704 may be, be similar to, include, or be included in a scrollable region of the graphical user interface 700 positioned on a right side of the graphical user interface 700. In some implementations, the editor pane 704 may support a plurality of display modes, including a raw-event display mode, a schema-preview display mode, a pipeline-plan display mode, a pipeline-configuration display mode, and a diff display mode.

A text input box 706 (which may also be referred to as a chat input or a user-input field) may be configured to receive free-form text input from the user for delivery to the schematizer agent 404. The text input box 706 may be, be similar to, include, or be included in an input element of the chat pane 702 positioned near a bottom of the chat pane 702. For example, in FIG. 7A the text input box 706 may display a placeholder "Help me with..." inviting the user to enter a free-form instruction.

A selectable input element 708 (which may also be referred to as a suggestion element) may be configured to facilitate initiation of a workflow step associated with collection of sample log data. The selectable input element 708 may be, be similar to, include, or be included in a clickable button rendered within the chat pane 702. In some implementations, the selectable input element 708 may display a text label such as "Collect sample events" that indicates a workflow step corresponding to selection of the selectable input element 708. Upon selection of the selectable input element 708, the frontend 402 may transmit a corresponding request to the schematizer agent 404 to initiate collection of the sample log data.

A selectable input element 710 may be configured to facilitate initiation of a workflow step associated with creation of a target schema file. The selectable input element 710 may be, be similar to, include, or be included in a clickable button rendered within the chat pane 702. In some implementations, the selectable input element 710 may display a text label such as "Create a target schema file" that indicates a workflow step corresponding to selection of the selectable input element 710. Upon selection of the selectable input element 710, the frontend 402 may transmit a corresponding request to the schematizer agent 404 to initiate selection or generation of the target schema.

A selectable input element 712 may be configured to facilitate initiation of a workflow step associated with creation of a pipeline plan file. The selectable input element 712 may be, be similar to, include, or be included in a clickable button rendered within the chat pane 702. In some implementations, the selectable input element 712 may display a text label such as "Create a pipeline plan file" that indicates a workflow step corresponding to selection of the selectable input element 712. Upon selection of the selectable input element 712, the frontend 402 may transmit a corresponding request to the schematizer agent 404 to initiate generation of the pipeline plan.

A cursor 714 (which may also be referred to as a pointer) may be configured to indicate a click target of the user within the graphical user interface 700. The cursor 714 may be, be similar to, include, or be included in a visual indicator rendered over any of the selectable input elements of the graphical user interface 700. In FIG. 7A, the cursor 714 is positioned over the selectable input element 708 to indicate that the user may select the selectable input element 708 to proceed with collection of the sample log data.

In some implementations, the graphical user interface 700 may support a default initial state prior to any input provided by the user. In the initial state, the chat pane 702 may display a natural-language message originated by the schematizer agent 404 such as "We need to start by collecting sample input events to understand the data we are working with", followed by the selectable input element 708, the selectable input element 710, and the selectable input element 712 as next-step suggestions. The editor pane 704 may be empty or may display a placeholder prior to capture of the sample log data.

In some implementations, the graphical user interface 700 may be rendered in response to a launch schematizer request transmitted from the user device 104 shown in FIG. 1 through the frontend 402 to the schematizer agent 404. In some implementations, upon receipt of the launch schematizer request, the schematizer agent 404 may populate the chat pane 702 with the selectable input element 708, the selectable input element 710, and the selectable input element 712 through a frontend tools mechanism, providing a mechanism by which the user may advance the log-schematization workflow without entering free-form text at each step.

In some implementations, upon a user entering the data processing platform through the graphical user interface 700, the data processing platform may automatically initiate a log-schematization conversation between the user and the schematizer agent 404, such that the user is presented with an initial prompt from the schematizer agent 404 in the chat pane 702 without an explicit user action to initiate the conversation. In some implementations, at each of a plurality of steps of the log-schematization workflow, the schematizer agent 404 may return, to the frontend 402, three selectable input elements representing three alternative next steps of the log-schematization workflow, and the user may select one of the three selectable input elements through the graphical user interface 700 to proceed with the log-schematization workflow. In some implementations, a schema selected by the schema agent 408 shown in FIG. 4 may be presented to the user through the graphical user interface 700 as a JavaScript Object Notation (JSON) Schema object representation that specifies field names, field types, and constraints of the schema in a format conforming to a JSON Schema specification.

FIG. 7B is an example user interface of a pipeline generation framework architecture. The example user interface depicted in FIG. 7B depicts a state of the graphical user interface 700 described above with reference to FIG. 7A, and may be understood with reference to the chat pane 702, the editor pane 704, the text input box 706, and the cursor 714 described with reference to FIG. 7A. FIG. 7B depicts the graphical user interface 700 at a source-selection state that follows selection of the selectable input element 708 of FIG. 7A.

A representation of a selection 716 (which may also be referred to as a progress indicator) may be configured to indicate advancement of the log-schematization workflow to a corresponding workflow step. The representation of a selection 716 may be, be similar to, include, or be included in a rendered element of the chat pane 702 displayed in response to selection of the selectable input element 708 shown in FIG. 7A. In some implementations, the representation of a selection 716 may be rendered with a dashed outline to visually distinguish the representation of a selection 716 from selectable input elements that remain actionable. For example, the representation of a selection 716 may display a text label such as "Proceed with step Collect sample input events" that reflects the corresponding workflow step that has been initiated.

A drop-down menu 718 (which may also be referred to as a source picker or a selection menu) may be configured to present a plurality of options corresponding to data sources from which sample log data may be captured. The drop-down menu 718 may be, be similar to, include, or be included in a drop-down element rendered within the chat pane 702 below the representation of a selection 716. In some implementations, the drop-down menu 718 may display a set of source identifiers and may facilitate selection by the user of one of the source identifiers as the data source for the log-schematization workflow. Examples of source identifiers displayed within the drop-down menu 718 include, but are not limited to, "http" corresponding to a hypertext-transfer-protocol (HTTP) ingestion source, "in_syslog" corresponding to a syslog-protocol ingestion source, "in_tcp" corresponding to a transmission-control-protocol (TCP) ingestion source, and "in_tcp_json" corresponding to a TCP-based JavaScript-object-notation (JSON) ingestion source. In some implementations, the drop-down menu 718 may be populated at runtime based on connected data sources available through the edge platform 112, the stream platform 110, or the search platform 108 shown in FIG. 1.

The cursor 714 described above with reference to FIG. 7A may be positioned over one of the source identifiers of the drop-down menu 718 to indicate a click target of the user. In FIG. 7B, the cursor 714 is positioned over the "in_syslog" source identifier to indicate that the user may select the "in_syslog" source identifier as the data source.

In some implementations, the graphical user interface 700 may transition from the state of FIG. 7A to the state of FIG. 7B in response to the user selecting the selectable input element 708 shown in FIG. 7A. In the state of FIG. 7B, the chat pane 702 may continue to display conversational history above the representation of a selection 716 and may continue to display the text input box 706 near a bottom of the chat pane 702. The editor pane 704 may remain empty or may display a placeholder, because capture of sample log data has not yet been completed.

In some implementations, the chat pane 702 of FIG. 7B may include a further natural-language message originated by the schematizer agent 404 of FIG. 4 that prompts the user to select a data source. For example, the natural-language message may read, in substance, "We need to start by collecting sample input events to understand the data we are working with" to indicate that a further input is requested from the user.

In some implementations, upon selection of the "in_syslog" source identifier by the user through the cursor 714, the frontend 402 of FIG. 4 may transmit a confirm source request to the schematizer agent 404, where the request includes an identifier of the selected data source and is written into the context object maintained by the frontend 402. In some implementations, the context object may be transmitted to the schematizer agent 404 as part of the confirm source request.

In some implementations, the drop-down menu 718 may be populated through a server-side tool such as a source-discovery tool invoked by the schematizer agent 404, where the source-discovery tool returns a set of available data sources for rendering in the drop-down menu 718. In some implementations, the drop-down menu 718 may be augmented with a search field or a text input such that the user may type a source identifier rather than scrolling to the source identifier within the drop-down menu 718.

In some implementations, selection of a source identifier through the drop-down menu 718 may trigger subsequent interactions described with reference to FIG. 6A, including a confirm source interaction transmitted from the frontend 402 to the schematizer agent 604 of FIG. 6A, and a capture sample events interaction transmitted from the schematizer agent 604 to the frontend 602 of FIG. 6A to prompt the user to confirm capture of the sample log data from the selected data source.

In some implementations, where the drop-down menu 718 is closed without selection of a source identifier, the graphical user interface 700 may return to the state of FIG. 7A, and the selectable input element 708, the selectable input element 710, and the selectable input element 712 shown in FIG. 7A may again be displayed as next-step suggestions in the chat pane 702.

The example user interface depicted in FIG. 7C depicts a state of the graphical user interface 700 described above with reference to FIG. 7A, and may be understood with reference to the chat pane 702, the editor pane 704, the text input box 706, the cursor 714, and the representation of a selection 716 described with reference to FIGS. 7A and 7B. FIG. 7C depicts the graphical user interface 700 following confirmation of the data source and capture of a bounded plurality of events from the data source.

A representation of a selection 720 (which may also be referred to as a progress indicator) may be configured to indicate that the data source has been selected by the user. The representation of a selection 720 may be, be similar to, include, or be included in a rendered element of the chat pane 702 displayed below the representation of a selection 716. In some implementations, the representation of a selection 720 may be rendered with a dashed outline and may display a text label such as "Selected source in_syslog" that reflects the selected data source.

A representation of a system action 722 (which may also be referred to as a status indicator or a capture indicator) may be configured to indicate that a bounded plurality of events has been captured from the data source. The representation of a system action 722 may be, be similar to, include, or be included in a rendered element of the chat pane 702 displayed below the representation of a selection 720. In some implementations, the representation of a system action 722 may be rendered with a dashed outline and may display a text label such as "Captured 3 events" that reflects a number of events captured from the data source.

A selectable input element 724 may be configured to facilitate initiation of a workflow step associated with creation of a target schema file following capture of the sample log data. The selectable input element 724 may be, be similar to, include, or be included in a clickable button rendered within the chat pane 702 below the representation of a system action 722. In some implementations, the selectable input element 724 may display a text label such as "Create a target schema file". Upon selection of the selectable input element 724, the frontend 402 shown in FIG. 4 may transmit a corresponding request to the schematizer agent 404 to initiate selection or generation of the target schema based on the sample log data.

A selectable input element 726 may be configured to facilitate initiation of a workflow step associated with creation of a pipeline plan file following capture of the sample log data. The selectable input element 726 may be, be similar to, include, or be included in a clickable button rendered within the chat pane 702 below the selectable input element 724. In some implementations, the selectable input element 726 may display a text label such as "Create a pipeline plan file". Upon selection of the selectable input element 726, the frontend 402 may transmit a corresponding request to the schematizer agent 404 to initiate generation of the pipeline plan.

A selectable input element 728 may be configured to facilitate initiation of a workflow step associated with creation of a pipeline file following capture of the sample log data. The selectable input element 728 may be, be similar to, include, or be included in a clickable button rendered within the chat pane 702 below the selectable input element 726. In some implementations, the selectable input element 728 may display a text label such as "Create a pipeline file". Upon selection of the selectable input element 728, the frontend 402 may transmit a corresponding request to the schematizer agent 404 to initiate generation of the data pipeline based on a previously generated pipeline plan.

An event data 730 (which may also be referred to as sample event data or raw events) may be configured to represent the bounded plurality of events captured from the data source and displayed within the editor pane 704 for review by the user. The event data 730 may be, be similar to, include, or be included in a set of records displayed in a JavaScript-object-notation (JSON) format, a syslog-protocol format, a raw-text format, or a combination thereof, depending on a format of the data source. For example, a given event of the event data 730 may include fields such as an event-type indicator, a timestamp, a facility value, a facility-name value, a severity value, a source value, an input identifier, a message body, or a combination thereof. In some implementations, the event data 730 may be stored by the frontend 402 shown in FIG. 4 as a sample file that is referenced by the context object maintained by the frontend 402 prior to transmission of a next request of the successive requests.

The cursor 714 described above with reference to FIG. 7A may be positioned over the selectable input element 724 to indicate a click target of the user. In FIG. 7C, the cursor 714 is positioned over the selectable input element 724 to indicate that the user may select the selectable input element 724 to proceed with creation of the target schema file.

In some implementations, the graphical user interface 700 may transition from the state of FIG. 7B to the state of FIG. 7C upon completion of a take capture operation and a send capture events operation described with reference to FIG. 6A. In the state of FIG. 7C, the chat pane 702 displays the representation of a selection 716, the representation of a selection 720, and the representation of a system action 722 as progress indicators reflecting prior steps of the log-schematization workflow, followed by the selectable input element 724, the selectable input element 726, and the selectable input element 728 as next-step suggestions. The editor pane 704 displays the event data 730 captured from the data source.

In some implementations, the event data 730 shown in the editor pane 704 may be interactive, such that the user may select a given field of a given event of the event data 730 to view additional information about the field, to exclude the field from the workflow, or to provide a hint to the schematizer agent 404 regarding the field. In some implementations, the graphical user interface 700 may support an option to drop a category of input data determined to not be relevant to the log-schematization workflow prior to inference of the log type.

The example user interface depicted in FIG. 7D depicts a state of the graphical user interface 700 described above with reference to FIG. 7A, and may be understood with reference to the chat pane 702, the editor pane 704, the text input box 706, the representation of a selection 716, the representation of a selection 720, the representation of a system action 722, and the event data 730 described with reference to FIGS. 7A, 7B, and 7C. FIG. 7D depicts the graphical user interface 700 following selection of the selectable input element 724 shown in FIG. 7C, during a free-form specification of a target schema by the user.

A representation of a system action 732 (which may also be referred to as a progress indicator) may be configured to indicate that a workflow step corresponding to creation of a target schema file has been initiated. The representation of a system action 732 may be, be similar to, include, or be included in a rendered element of the chat pane 702 displayed below the representation of a system action 722. In some implementations, the representation of a system action 732 may be rendered with a dashed outline and may display a text label such as "Proceed with step Create a target schema file" that reflects the corresponding workflow step that has been initiated.

In some implementations, the chat pane 702 of FIG. 7D may include a natural-language prompt originated by the schematizer agent 404 shown in FIG. 4 or by the schema agent 408 shown in FIG. 4 that requests a description of the target schema from the user. For example, the natural-language prompt may read, in substance, "Please describe the target schema", providing a mechanism by which the user may specify the target schema through free-form text input rather than through selection of a predefined schema identifier.

The text input box 706 of FIG. 7D may display the free-form text input entered by the user in response to the natural-language prompt. For example, the text input box 706 may display free-form text such as "convert it to ocsf base", indicating that the user wishes to select an Open Cybersecurity Schema Framework (OCSF) base schema as the target schema for transformation of the sample log data. In some implementations, the free-form text input entered by the user may be forwarded by the frontend 402 shown in FIG. 4 to the schematizer agent 404, which delegates the free-form text input to the schema agent 408 for retrieval of the target schema from the schema registry 416 shown in FIG. 4.

In some implementations, the free-form text input may include a schema family identifier (such as OCSF, Elastic Common Schema (ECS), or Unified Data Model (UDM)), a schema variant identifier (such as "base", "network_activity", or "authentication"), or a combination thereof. In some implementations, the schema agent 408 may use the free-form text input to identify one or more candidate schemas in the schema registry 416 that match the free-form text input, and may invoke a language model to select the target schema from among the candidate schemas.

In some implementations, where the free-form text input does not correspond to any schema in the schema registry 416, the schema agent 408 may generate a new schema based on a coverage condition evaluated with respect to the sample log data and the free-form text input, and may store the new schema in the schema registry 416 for subsequent retrieval.

The chat pane 702 of FIG. 7D continues to display the representation of a selection 716, the representation of a selection 720, and the representation of a system action 722 described above with reference to FIGS. 7B and 7C, together with the representation of a system action 732 described above. Through this arrangement, the chat pane 702 maintains a visible record of prior steps of the log-schematization workflow for the user to review.

The editor pane 704 of FIG. 7D continues to display the event data 730 described above with reference to FIG. 7C. In some implementations, the event data 730 remains visible within the editor pane 704 throughout the specification of the target schema, providing a mechanism by which the user may refer to the captured event data while specifying the target schema.

In some implementations, upon entry of the free-form text input and activation of a submission control, the frontend 402 shown in FIG. 4 may transmit a request to the schematizer agent 404 that includes the free-form text input and the context object maintained by the frontend 402. In some implementations, upon receipt of the response from the schematizer agent 404 that includes the target schema, the frontend 402 writes the target schema into the context object prior to transmission of a next request of the successive requests.

In some implementations, the graphical user interface 700 may support a cancel control or a revise control through which the user may cancel the specification of the target schema or revise the free-form text input prior to submission. In some implementations, the graphical user interface 700 may support an option to select the target schema from a list of predefined schema identifiers rather than through free-form text input, and may transition between the free-form text input mode and the list-selection mode at the direction of the user.

The example user interface depicted in FIG. 7E depicts a state of the graphical user interface 700 described above with reference to FIG. 7A, and may be understood with reference to the chat pane 702, the editor pane 704, the text input box 706, the representation of a selection 716, the representation of a selection 720, the representation of a system action 722, and the representation of a system action 732 described with reference to FIGS. 7A, 7B, 7C, and 7D. FIG. 7E depicts the graphical user interface 700 following retrieval of a target schema from the schema registry 416 shown in FIG. 4 by the schema agent 408 shown in FIG. 4, and presentation of the target schema to the user for confirmation.

An output 734 (which may also be referred to as a file preview, a schema preview, or a transformed-event-data preview) may be configured to display content associated with a current step of the log-schematization workflow within the editor pane 704. The output 734 may be, be similar to, include, or be included in a rendered representation of a file accessible to the frontend 402 shown in FIG. 4. In FIG. 7E, the output 734 represents a preview of a target-schema file retrieved from the schema registry 416 shown in FIG. 4, the target-schema file including a schema definition including a schema identifier (for example, a "$schema" field referencing a schema language such as a draft-04 schema for JavaScript-object-notation (JSON)), a title (for example, "OCSF (Base)"), a description, a type indicator, and a set of properties each including a field-name identifier, a type indicator, a description, a set of enumerated values, and associated enumeration descriptions. Examples of properties depicted in the output 734 include an "activity_id" integer property and an "activity_name" string property. In some implementations, the output 734 may be displayed in a later state of the graphical user interface 700 as a representation of transformed event data produced by the data pipeline applied to the sample log data, providing a mechanism by which the user may confirm that the output of the data pipeline conforms to the target schema prior to committing the data pipeline for processing of data from the data source.

A selectable representation of an action 736 (which may also be referred to as a confirmation control or a proceed button) may be configured to receive input from the user to advance the log-schematization workflow. The selectable representation of an action 736 may be, be similar to, include, or be included in a clickable button rendered within the chat pane 702. In some implementations, the selectable representation of an action 736 may display a text label such as "Proceed". Upon selection of the selectable representation of an action 736 by the user, the frontend 402 shown in FIG. 4 may transmit a corresponding request to the schematizer agent 404 shown in FIG. 4 to advance the log-schematization workflow to a pipeline-plan generation step, as further described with reference to FIG. 6B.

In some implementations, the chat pane 702 of FIG. 7E may include a natural-language message originated by the schematizer agent 404 that reflects a result of the schema-retrieval step, such as a message reading, in substance, "Schema agent retrieved OCSF base schema. Please review the content and confirm", followed by the selectable representation of an action 736. In some implementations, the chat pane 702 of FIG. 7E may display a list of files generated over the course of the log-schematization workflow, including a sample_events file corresponding to the event data 730 described with reference to FIG. 7C and a target_schema file corresponding to the output 734. In some implementations, the list of files may be interactive such that the user may select a given file to display the content of the given file within the editor pane 704.

The chat pane 702 of FIG. 7E continues to display the representation of a selection 716, the representation of a selection 720, the representation of a system action 722, and the representation of a system action 732 described above with reference to FIGS. 7B, 7C, and 7D. Through this arrangement, the chat pane 702 maintains a visible record of prior steps of the log-schematization workflow for the user to review.

The editor pane 704 of FIG. 7E displays the output 734. In some implementations, the output 734 may be scrollable such that the user may view additional properties of the schema definition that are not initially visible within the editor pane 704. In some implementations, the output 734 may be editable such that the user may modify the schema definition prior to confirmation and, upon modification, the modified schema definition may be stored in the schema registry 416 through the schema agent 408.

In some implementations, upon selection of the selectable representation of an action 736 by the user, the frontend 402 shown in FIG. 4 may write the target schema (or a reference thereto) into the context object maintained by the frontend 402 prior to transmission of a next request of the successive requests. In some implementations, the next request may include a delegation to the pipeline plan agent 412 shown in FIG. 4 to generate the pipeline plan based on the sample log data, the log type, and the target schema, as further described with reference to FIG. 6B.

In some implementations, the graphical user interface 700 may support a cancel control or a revise control through which the user may reject the retrieved target schema and either select a different target schema or request a modification. In some implementations, where the user rejects the retrieved target schema, the schema agent 408 may retrieve one or more additional candidate schemas from the schema registry 416 or may generate a new schema based on a coverage condition evaluated with respect to the sample log data, as further described with reference to FIG. 4.

In some implementations, the graphical user interface 700 may support a diff display mode for the editor pane 704 in a later state of the log-schematization workflow, where the editor pane 704 displays a side-by-side comparison between a raw input event of the event data 730 described with reference to FIG. 7C and a corresponding output record produced by applying the data pipeline to the raw input event. Through this arrangement, the graphical user interface 700 may provide a mechanism by which the user may confirm that the data pipeline produces records conforming to the target schema prior to committing the data pipeline for processing of data from the data source.

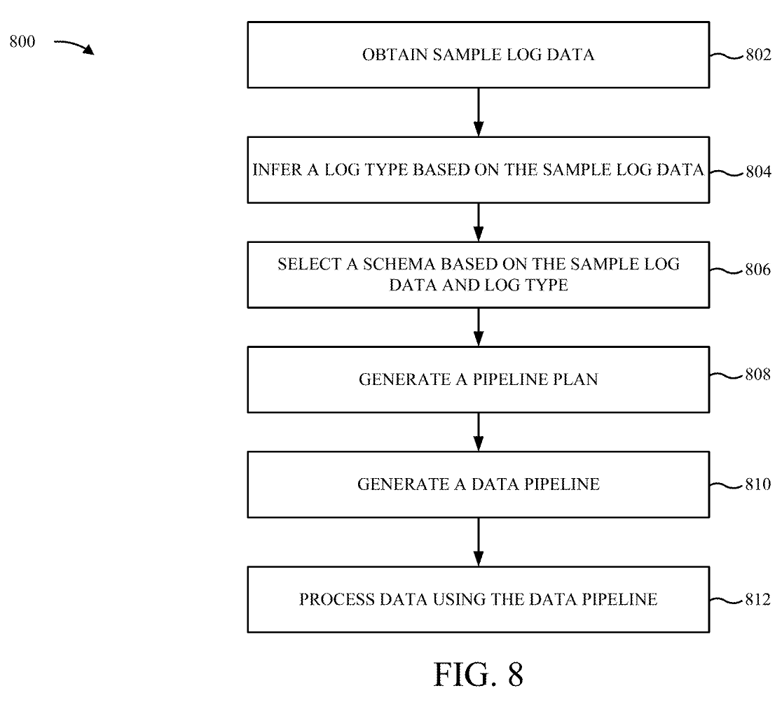

To further describe some implementations in greater detail, reference is next made to examples of techniques which may be performed by or using the pipeline generation framework architecture described herein. FIG. 8 is a flowchart of an example of a log-schematization method 800 associated with log schematization using an agentic framework. The method 800 may be executed using computing devices, such as the systems, hardware, and software described with respect to FIGS. 1, 2, 3, 4, 5A, 5B, 6A, 6B, and 7A-7E. The method 800 may be performed, for example, by executing a machine-readable program or other computer-executable instructions such as routines, instructions, programs, or other code stored in the memory 206 of the computing device 200 shown in FIG. 2 and executed by the processor 204 of the computing device 200. The operations of the method 800, or another method, process, or algorithm described in connection with the implementations disclosed herein, may be implemented directly in hardware, firmware, software executed by hardware, circuitry, or a combination thereof.

For simplicity of explanation, the method 800 is depicted and described herein as a series of steps or operations. However, the steps or operations of the method 800 may occur in various orders or concurrently, additional steps or operations not presented and described herein may be used, and not all illustrated steps or operations may be used to implement a technique in accordance with the disclosed subject matter.

The method 800 may be carried out through a plurality of successive requests transmitted from a client to a server system, where the client may be, be similar to, include, or be included in the client 120 shown in FIG. 1 or the frontend 402 shown in FIG. 4, and where the server system may be, be similar to, include, or be included in the system 102 shown in FIG. 1 that hosts the agent system 116 shown in FIG. 1. Each of the successive requests may include a context object maintained by the client that reflects one or more prior steps of the method 800. The server system does not retain state associated with the method 800 between the successive requests. In some implementations, each of the successive requests may be transmitted over a stateless application-layer protocol such as the hypertext transfer protocol (HTTP) or a variant thereof, and a session identifier is not used by the server system to associate any of the successive requests with any other of the successive requests. In some implementations, each of the successive requests may be independently authenticated and independently authorized by the server system, and the server system may validate a signature of the context object in each of the successive requests. In some implementations, the context object may include an identifier of a data source, sample log data or a reference to the sample log data, a log type, a schema, a pipeline plan, or a combination thereof. In some implementations, the server system may include a plurality of servers, and at least two of a first automated agent, a second automated agent, a third automated agent, a fourth automated agent, and a fifth automated agent of the method 800 may execute on different ones of the plurality of servers.

At 802, the method 800 includes obtaining, utilizing a first automated agent, sample log data corresponding to a data source. For example, the first automated agent may be, be similar to, include, or be included in the schematizer agent 404 shown in FIG. 4. In some implementations, the obtaining at 802 may include capturing the sample log data from the data source through a capture-from-source step, selecting the sample log data from a previously saved sample file through a select-existing-sample step, receiving the sample log data from a user through a copy-events-into-chat step, or a combination thereof, as further described with reference to FIG. 5A. In some implementations, the first automated agent may receive the sample log data from the client, may invoke a language model to characterize a format of the sample log data, and may return a schematization result to the client, where the schematization result is written by the client into the context object prior to transmission of a next request of the successive requests.

At 804, the method 800 includes inferring, utilizing a second automated agent and a log type registry, a log type based on the sample log data. For example, the second automated agent may be, be similar to, include, or be included in the log type inference agent 406 shown in FIG. 4, and the log type registry may be, be similar to, include, or be included in the log type registry 414 shown in FIG. 4. In some implementations, the inferring at 804 may include retrieving, from the log type registry, a plurality of candidate log type definitions, invoking a language model with the sample log data and the candidate log type definitions as input, and returning, to the client, the log type selected from among the candidate log type definitions. In some implementations, the retrieving of the candidate log type definitions from the log type registry may be based on a similarity measure computed between a representation of the sample log data and representations of entries in the log type registry, where examples of the similarity measure include, but are not limited to, a cosine similarity between vector embeddings, a lexical similarity score such as a best-matching-25 (BM25) score, a fuzzy string similarity score, and a structural schema similarity score.

At 806, the method 800 includes selecting, utilizing a third automated agent and a schema registry, a schema based on the sample log data and the log type. For example, the third automated agent may be, be similar to, include, or be included in the schema agent 408 shown in FIG. 4, and the schema registry may be, be similar to, include, or be included in the schema registry 416 shown in FIG. 4. In some implementations, the selecting at 806 may include retrieving, from the schema registry, a plurality of candidate schemas associated with the log type, invoking a language model with the sample log data, the log type, and the candidate schemas as input, and returning, to the client, the schema selected from among the candidate schemas. In some implementations, where no candidate schema in the schema registry satisfies a coverage condition with respect to the sample log data, the selecting at 806 may include generating, utilizing the third automated agent, a new schema and storing the new schema in the schema registry, where the coverage condition may include a threshold percentage of fields of the sample log data that are mapped to fields of a candidate schema, a criterion that a field of a specified kind be present in a candidate schema, a similarity-score threshold between a structure of the sample log data and a structure of a candidate schema, a criterion based on absence of a material field type within a candidate schema, or a combination thereof. In some implementations, the retrieving from the schema registry may include a tool call that reads from the schema registry.

At 808, the method 800 includes generating, utilizing a fourth automated agent, a pipeline plan based on the sample log data, the log type, and the schema. For example, the fourth automated agent may be, be similar to, include, or be included in the pipeline plan agent 412 shown in FIG. 4. In some implementations, the generating at 808 may include invoking a language model to produce the pipeline plan as a structured representation specifying a sequence of data processing functions, one or more parameters for each of the data processing functions, and a mapping between fields of the sample log data and fields of the schema. In some implementations, the structured representation may be produced through constrained decoding of the language model, where examples of constrained decoding include, but are not limited to, grammar-constrained decoding, decoding constrained by a schema for JavaScript Object Notation (JSON), finite-state-machine-driven decoding, and biasing of token-selection logits against tokens that would violate a specified structure. In some implementations, the generating at 808 may further include few-shot prompting using worked examples retrieved from an example registry and chain-of-thought prompting that directs the language model to articulate intermediate reasoning steps.

At 810, the method 800 includes generating, utilizing a fifth automated agent, a data pipeline based on the pipeline plan, the data pipeline including an ordered arrangement of data processing functions configured to transform event data from the data source into records conforming to the schema and to deliver the records to a destination. For example, the fifth automated agent may be, be similar to, include, or be included in the pipeline agent 410 shown in FIG. 4. In some implementations, the generating at 810 may include compiling the pipeline plan into an executable configuration for a data processing engine, where the executable configuration defines the ordered arrangement of the data processing functions. In some implementations, the data processing functions may include one or more of a parsing function configured to extract a field from an input event, an enrichment function configured to add information to a record from one or more external sources, a normalization function configured to align field names and field values with conventions of the schema, a redaction function configured to mask or remove a sensitive field value, and a routing function configured to deliver a record to at least one destination. In some implementations, the destination may include at least one of a log analytics system, an object store, a search index, a security information and event management (SIEM) system, and a data lake. In some implementations, the generating at 810 may include assembling a pipeline generation prompt that includes the sample log data, the pipeline plan, one or more function-type definitions retrieved from a function type registry, and one or more few-shot examples retrieved from an example registry, as further described with reference to FIG. 5B.

In some implementations, the method 800 may further include validating the data pipeline by applying the data pipeline to at least a portion of the sample log data, comparing an output of the data pipeline to the schema, and, conditioned on a validation result, committing the data pipeline for processing of data from the data source. The comparing may include evaluating whether the output conforms to field names, field types, and semantic conventions of the schema. Where the validation result indicates that the output does not conform to the schema, control may return to the selecting at 806, the generating at 808, or the generating at 810, for modification of the schema, the pipeline plan, or the data pipeline, respectively, or for recapture of the sample log data from the data source.

At 812, the method 800 includes processing data from the data source using the data pipeline. For example, the processing at 812 may include delivering the data pipeline to the stream platform 110 shown in FIG. 1, ingesting event data from the data source into the stream platform 110, executing the ordered arrangement of the data processing functions of the data pipeline against the event data, and delivering the records to the destination. In some implementations, the processing at 812 may include continual processing, periodic processing, processing in response to a trigger event, or a combination thereof. In some implementations, the processing at 812 may include delivering the records to a plurality of destinations through one or more routing functions of the data pipeline.

In some implementations, the first automated agent, the second automated agent, the third automated agent, the fourth automated agent, and the fifth automated agent may each include processor-executable instructions that, when executed, invoke a language model. In some implementations, the language model invoked by at least one of the first automated agent, the second automated agent, the third automated agent, the fourth automated agent, and the fifth automated agent may be selected from a plurality of language models based on a characteristic of the sample log data or a computational budget associated with a request, where examples of the characteristic include a volume, a complexity indicator, a sensitivity classification, and a format-family indicator of the sample log data, and where examples of the computational budget include a latency budget, a monetary cost budget, and a service-tier classification of a tenancy associated with the request. In some implementations, the language model may be a large language model, a small language model, a natural-language-processing model, a neural network, or a combination thereof.

In some implementations, at least one of the first automated agent, the second automated agent, the third automated agent, the fourth automated agent, and the fifth automated agent may invoke the language model through one or more tool calls, where the tool calls include at least one call that reads from the log type registry or the schema registry. In some implementations, the tool calls may be executed on the server system, in which case the respective automated agent appends a result of the tool call to an internal message sequence and continues execution of the respective automated agent. In some implementations, the tool calls may be executed on the client, in which case execution of the respective automated agent is yielded to the client together with an intermediate message sequence, the client executes the tool, appends a result of the tool call to the message sequence, and reinvokes the respective automated agent with the updated message sequence.

In operation, the method 800 transforms heterogeneous event data from a data source into records conforming to a schema through the coordinated operation of a plurality of automated agents executing on a stateless server system under direction of a client that maintains a context object across a plurality of successive requests, providing a mechanism by which the pipeline generation framework architecture described herein may facilitate horizontally scalable, resilient, and auditable log schematization for the data processing platform of FIG. 1.

Some implementations include a method, comprising: obtaining, utilizing a first automated agent, sample log data corresponding to a data source; inferring, utilizing a second automated agent and a log type registry, a log type based on the sample log data; selecting, utilizing a third automated agent and a schema registry, a schema based on the sample log data and the log type; generating, utilizing a fourth automated agent, a pipeline plan based on the sample log data, the log type, and the schema; generating, utilizing a fifth automated agent, a data pipeline based on the pipeline plan, the data pipeline comprising an ordered arrangement of data processing functions configured to transform event data from the data source into records conforming to the schema and to deliver the records to a destination; and processing data from the data source using the data pipeline, wherein each of the first automated agent, the second automated agent, the third automated agent, the fourth automated agent, and the fifth automated agent comprises processor-executable instructions that, when executed, invoke a language model component, wherein each of the first automated agent, the second automated agent, the third automated agent, the fourth automated agent, and the fifth automated agent executes on a server system comprising one or more servers and is invoked by a client through a respective request of a plurality of successive requests, each of the plurality of successive requests including a context object maintained by the client, the context object in each successive request reflecting output received by the client in response to one or more prior successive requests of the plurality of successive requests, and wherein the server system does not retain state derived from any of the plurality of successive requests between successive ones of the plurality of successive requests.

In some implementations, the first automated agent comprises processor-executable instructions that, when executed, cause the first automated agent to: receive the sample log data from the client; invoke the language model component to characterize a format of the sample log data; and return, to the client, a schematization result that is written by the client into the context object.

In some implementations, the second automated agent comprises processor-executable instructions that, when executed, cause the second automated agent to: retrieve, from the log type registry, a plurality of candidate log type definitions; invoke the language model component with the sample log data and the candidate log type definitions as input; and return, to the client, the log type selected from among the candidate log type definitions.

In some implementations, the plurality of candidate log type definitions is retrieved from the log type registry based on a similarity measure computed between a representation of the sample log data and representations of entries in the log type registry.

In some implementations, the third automated agent comprises processor-executable instructions that, when executed, cause the third automated agent to: retrieve, from the schema registry, a plurality of candidate schemas associated with the log type; invoke the language model component with the sample log data, the log type, and the candidate schemas as input; and return, to the client, the schema selected from among the candidate schemas.

In some implementations, the method further comprises generating, utilizing the third automated agent when no candidate schema in the schema registry satisfies a coverage condition with respect to the sample log data, a new schema and storing the new schema in the schema registry.

In some implementations, the fourth automated agent comprises processor-executable instructions that, when executed, cause the fourth automated agent to invoke the language model component to produce the pipeline plan as a structured representation specifying a sequence of data processing functions, parameters for each of the data processing functions, and a mapping between fields of the sample log data and fields of the schema.

In some implementations, the structured representation conforms to a schema enforced during generation by the fourth automated agent through constrained decoding of the language model component.

In some implementations, the fifth automated agent comprises processor-executable instructions that, when executed, cause the fifth automated agent to compile the pipeline plan into an executable configuration for a data processing engine, the executable configuration defining the ordered arrangement of the data processing functions.

In some implementations, the context object comprises (i) an identifier of the data source, (ii) the sample log data or a reference thereto, (iii) the log type after inference, (iv) the schema after selection, and (v) the pipeline plan after generation, and wherein the client writes a respective output of each agent into the context object before transmitting a next request of the successive requests.

In some implementations, each of the successive requests is independently authenticated and independently authorized by the server system, and wherein the server system validates a signature of the context object in each of the successive requests.

In some implementations, the data processing functions of the data pipeline comprise at least one of a parsing function, an enrichment function, a normalization function, a redaction function, or a routing function that delivers the records to the destination.

In some implementations, the destination comprises at least one of a log analytics system, an object store, a search index, a security information and event management system, or a data lake.

Some implementations include one or more non-transitory computer-readable storage media storing instructions that, when executed by one or more processors, cause the one or more processors to perform operations, the operations comprising: receiving, from a server system in response to a first request directed to a first automated agent, sample log data corresponding to a data source; receiving, from the server system in response to a second request directed to a second automated agent and identifying the sample log data, a log type inferred based on the sample log data and a log type registry; receiving, from the server system in response to a third request directed to a third automated agent and identifying the sample log data and the log type, a schema selected based on the sample log data, the log type, and a schema registry; receiving, from the server system in response to a fourth request directed to a fourth automated agent and identifying the sample log data, the log type, and the schema, a pipeline plan generated based on the sample log data, the log type, and the schema; receiving, from the server system in response to a fifth request directed to a fifth automated agent and identifying the pipeline plan, a data pipeline generated based on the pipeline plan, the data pipeline comprising an ordered arrangement of data processing functions configured to transform event data from the data source into records conforming to the schema and to deliver the records to a destination; and initiating processing of data from the data source using the data pipeline, wherein each of the first automated agent, the second automated agent, the third automated agent, the fourth automated agent, and the fifth automated agent comprises processor-executable instructions that, when executed on the server system, invoke a language model component, wherein the first request, the second request, the third request, the fourth request, and the fifth request comprise a plurality of successive requests, each of the plurality of successive requests including a context object maintained by the client, the context object in each successive request reflecting output received by the client in response to one or more prior successive requests of the plurality of successive requests, and wherein the server system does not retain state derived from any of the plurality of successive requests between successive ones of the plurality of successive requests.

In some implementations, the operations further comprise validating the data pipeline by: transmitting, to the server system, a validation request that causes the data pipeline to be applied to the sample log data; receiving, in response to the validation request, a validation result based on a comparison of an output of the data pipeline to the schema; and committing, based on the validation result, the data pipeline for processing.

In some implementations, output received by the client in response to at least one of the plurality of successive requests is generated by the corresponding automated agent invoking the language model component through one or more tool calls including at least one call that reads from the log type registry or the schema registry.

In some implementations, the language model component includes a plurality of language models from which a language model is selected for invocation based on at least one of a characteristic of the sample log data or a computational budget associated with the respective request.

In some implementations, the successive requests are transmitted to the server system over a stateless application-layer protocol, and wherein a session identifier is not required by the server system to associate any of the successive requests with any other of the successive requests.

Some implementations include a system, comprising: a memory; and a processor set configured to execute instructions stored in the memory to cause the system to perform operations, the operations comprising: receiving a plurality of successive requests from a client; returning, to the client in response to a first request of the plurality of successive requests, sample log data corresponding to a data source, the sample log data obtained utilizing a first automated agent; returning, to the client in response to a second request of the plurality of successive requests, a log type inferred utilizing a second automated agent and a log type registry based on the sample log data; returning, to the client in response to a third request of the plurality of successive requests, a schema selected utilizing a third automated agent and a schema registry based on the sample log data and the log type; returning, to the client in response to a fourth request of the plurality of successive requests, a pipeline plan generated utilizing a fourth automated agent based on the sample log data, the log type, and the schema; and returning, to the client in response to a fifth request of the plurality of successive requests, a data pipeline generated utilizing a fifth automated agent based on the pipeline plan, the data pipeline comprising an ordered arrangement of data processing functions configured to transform event data from the data source into records conforming to the schema and to deliver the records to a destination, wherein each of the first automated agent, the second automated agent, the third automated agent, the fourth automated agent, and the fifth automated agent comprises processor-executable instructions that, when executed, invoke a language model component, wherein each of the plurality of successive requests includes a context object maintained by the client, the context object in each successive request reflecting output returned by the server system in response to one or more prior successive requests of the plurality of successive requests, and wherein the server system does not retain state derived from any of the plurality of successive requests between successive ones of the plurality of successive requests.

In some implementations, the server system comprises a plurality of servers, and wherein at least two of the first automated agent, the second automated agent, the third automated agent, the fourth automated agent, or the fifth automated agent execute on different ones of the plurality of servers.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The adjectives “first,” “second,” “third,” and so on are used for contextual distinction between two or more of the modified nouns in connection with a discussion and are not meant to be absolute modifiers that apply only to a certain respective node throughout the entire document. For example, a component may be referred to as a “first component” in connection with one discussion and may be referred to as a “second component” in connection with another discussion, or vice versa. Reference to a component, a computing device, a server, a client, an application, an apparatus, a device, a system, a computing system, or the like may include disclosure of the computing device, server, client, application, apparatus, device, system, computing system, or the like, respectively, being a node. For example, disclosure that a computing device is configured to receive information from a server also discloses that a first node is configured to receive information from a second node. Consistent with this disclosure, once a specific example is broadened in accordance with this disclosure (e.g., a computing device is configured to receive information from a server also discloses that a first node is configured to receive information from a second node), the broader example of the narrower example may be interpreted in the reverse, but in a broad open-ended way. In the example above where a computing device being configured to receive information from a server also discloses a first node being configured to receive information from a second node, “first node” may refer to a first computing device, a first server, a first client, a first application, a first apparatus, a first device, a first system, a first computing system, or the like, configured to receive the information from a second node; and “second node” may refer to a second computing device, a second server, a second client, a second application, a second apparatus, a second device, a second system, a second computing system, or the like.

As used herein, unless explicitly stated otherwise, any term specified in the singular may include its plural version. For example, “a computer that stores data and runs software,” may include a single computer that stores data and runs software or two computers – a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by a processing system. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
obtaining, utilizing a first automated agent, sample log data corresponding to a data source;
inferring, utilizing a second automated agent and a log type registry, a log type based on the sample log data;
selecting, utilizing a third automated agent and a schema registry, a schema based on the sample log data and the log type;
generating, utilizing a fourth automated agent, a pipeline plan based on the sample log data, the log type, and the schema;
generating, utilizing a fifth automated agent, a data pipeline based on the pipeline plan, the data pipeline comprising an ordered arrangement of data processing functions configured to transform event data from the data source into records conforming to the schema and to deliver the records to a destination; and
processing data from the data source using the data pipeline,
wherein each of the first automated agent, the second automated agent, the third automated agent, the fourth automated agent, and the fifth automated agent comprises processor-executable instructions that, when executed, invoke a language model component,
wherein each of the first automated agent, the second automated agent, the third automated agent, the fourth automated agent, and the fifth automated agent executes on a server system comprising one or more servers and is invoked by a client through a respective request of a plurality of successive requests, each of the plurality of successive requests including a context object maintained by the client, the context object in each successive request reflecting output received by the client in response to one or more prior successive requests of the plurality of successive requests, and
wherein the server system does not retain state derived from any of the plurality of successive requests between successive ones of the plurality of successive requests.

2. The method of claim 1, wherein the first automated agent comprises processor-executable instructions that, when executed, cause the first automated agent to:
receive the sample log data from the client;
invoke the language model component to characterize a format of the sample log data; and
return, to the client, a schematization result that is written by the client into the context object.

3. The method of claim 1, wherein the second automated agent comprises processor-executable instructions that, when executed, cause the second automated agent to:
retrieve, from the log type registry, a plurality of candidate log type definitions;
invoke the language model component with the sample log data and the candidate log type definitions as input; and
return, to the client, the log type selected from among the candidate log type definitions.

4. The method of claim 3, wherein the plurality of candidate log type definitions is retrieved from the log type registry based on a similarity measure computed between a representation of the sample log data and representations of entries in the log type registry.

5. The method of claim 1, wherein the third automated agent comprises processor-executable instructions that, when executed, cause the third automated agent to:
retrieve, from the schema registry, a plurality of candidate schemas associated with the log type;
invoke the language model component with the sample log data, the log type, and the candidate schemas as input; and
return, to the client, the schema selected from among the candidate schemas.

6. The method of claim 5, further comprising: generating, utilizing the third automated agent when no candidate schema in the schema registry satisfies a coverage condition with respect to the sample log data, a new schema and storing the new schema in the schema registry.

7. The method of claim 1, wherein the fourth automated agent comprises processor-executable instructions that, when executed, cause the fourth automated agent to invoke the language model component to produce the pipeline plan as a structured representation specifying a sequence of data processing functions, parameters for each of the data processing functions, and a mapping between fields of the sample log data and fields of the schema.

8. The method of claim 7, wherein the structured representation conforms to a schema enforced during generation by the fourth automated agent through constrained decoding of the language model component.

9. The method of claim 1, wherein the fifth automated agent comprises processor-executable instructions that, when executed, cause the fifth automated agent to compile the pipeline plan into an executable configuration for a data processing engine, the executable configuration defining the ordered arrangement of the data processing functions.

10. The method of claim 1, wherein the context object comprises (i) an identifier of the data source, (ii) the sample log data or a reference thereto, (iii) the log type after inference, (iv) the schema after selection, and (v) the pipeline plan after generation, and wherein the client writes a respective output of each agent into the context object before transmitting a next request of the successive requests.

11. The method of claim 1, wherein each of the successive requests is independently authenticated and independently authorized by the server system, and wherein the server system validates a signature of the context object in each of the successive requests.

12. The method of claim 1, wherein the data processing functions of the data pipeline comprise at least one of a parsing function, an enrichment function, a normalization function, a redaction function, or a routing function that delivers the records to the destination.

13. The method of claim 1, wherein the destination comprises at least one of a log analytics system, an object store, a search index, a security information and event management system, or a data lake.

14. One or more non-transitory computer-readable storage media storing instructions that, when executed by one or more processors, cause the one or more processors to perform operations, the operations comprising:
receiving, from a server system in response to a first request directed to a first automated agent, sample log data corresponding to a data source;
receiving, from the server system in response to a second request directed to a second automated agent and identifying the sample log data, a log type inferred based on the sample log data and a log type registry;
receiving, from the server system in response to a third request directed to a third automated agent and identifying the sample log data and the log type, a schema selected based on the sample log data, the log type, and a schema registry;
receiving, from the server system in response to a fourth request directed to a fourth automated agent and identifying the sample log data, the log type, and the schema, a pipeline plan generated based on the sample log data, the log type, and the schema;
receiving, from the server system in response to a fifth request directed to a fifth automated agent and identifying the pipeline plan, a data pipeline generated based on the pipeline plan, the data pipeline comprising an ordered arrangement of data processing functions configured to transform event data from the data source into records conforming to the schema and to deliver the records to a destination; and
initiating processing of data from the data source using the data pipeline,
wherein each of the first automated agent, the second automated agent, the third automated agent, the fourth automated agent, and the fifth automated agent comprises processor-executable instructions that, when executed on the server system, invoke a language model component,
wherein the first request, the second request, the third request, the fourth request, and the fifth request comprise a plurality of successive requests, each of the plurality of successive requests including a context object maintained by the client, the context object in each successive request reflecting output received by the client in response to one or more prior successive requests of the plurality of successive requests, and
wherein the server system does not retain state derived from any of the plurality of successive requests between successive ones of the plurality of successive requests.

15. The one or more non-transitory computer-readable storage media of claim 14, the operations further comprising validating the data pipeline by:
transmitting, to the server system, a validation request that causes the data pipeline to be applied to the sample log data;
receiving, in response to the validation request, a validation result based on a comparison of an output of the data pipeline to the schema; and
committing, based on the validation result, the data pipeline for processing.

16. The one or more non-transitory computer-readable storage media of claim 14, wherein output received by the client in response to at least one of the plurality of successive requests is generated by the corresponding automated agent invoking the language model component through one or more tool calls including at least one call that reads from the log type registry or the schema registry.

17. The one or more non-transitory computer-readable storage media of claim 14, wherein the language model component includes a plurality of language models from which a language model is selected for invocation based on at least one of a characteristic of the sample log data or a computational budget associated with the respective request.

18. The one or more non-transitory computer-readable storage media of claim 14, wherein the successive requests are transmitted to the server system over a stateless application-layer protocol, and wherein a session identifier is not required by the server system to associate any of the successive requests with any other of the successive requests.

19. A system, comprising:
a memory; and
a processor set configured to execute instructions stored in the memory to cause the system to perform operations, the operations comprising:
receiving a plurality of successive requests from a client;
returning, to the client in response to a first request of the plurality of successive requests, sample log data corresponding to a data source, the sample log data obtained utilizing a first automated agent;
returning, to the client in response to a second request of the plurality of successive requests, a log type inferred utilizing a second automated agent and a log type registry based on the sample log data;
returning, to the client in response to a third request of the plurality of successive requests, a schema selected utilizing a third automated agent and a schema registry based on the sample log data and the log type;
returning, to the client in response to a fourth request of the plurality of successive requests, a pipeline plan generated utilizing a fourth automated agent based on the sample log data, the log type, and the schema; and
returning, to the client in response to a fifth request of the plurality of successive requests, a data pipeline generated utilizing a fifth automated agent based on the pipeline plan, the data pipeline comprising an ordered arrangement of data processing functions configured to transform event data from the data source into records conforming to the schema and to deliver the records to a destination,
wherein each of the first automated agent, the second automated agent, the third automated agent, the fourth automated agent, and the fifth automated agent comprises processor-executable instructions that, when executed, invoke a language model component,
wherein each of the plurality of successive requests includes a context object maintained by the client, the context object in each successive request reflecting output returned by the server system in response to one or more prior successive requests of the plurality of successive requests, and wherein the server system does not retain state derived from any of the plurality of successive requests between successive ones of the plurality of successive requests.

20. The system of claim 19, wherein the server system comprises a plurality of servers, and wherein at least two of the first automated agent, the second automated agent, the third automated agent, the fourth automated agent, or the fifth automated agent execute on different ones of the plurality of servers.
